(19) United States
(12) Patent Application Publication
(10) Pub. No.: US 2010/0262476 A1
(43) Pub. Date: Oct. 14, 2010

(54) METHODS AND SYSTEMS FOR SALES PROMOTION

(75) Inventor: Marc Amour, Rushcutters Bay (AU)

Correspondence Address: KATTEN MUCHIN ROSENMAN LLP;(C/O PATENT ADMINISTRATOR), 2900 K STREET NW, SUITE 200, WASHINGTON, DC, 20007-5118, US

(73) Assignee: G5 ENTERPRIZES PTY LTD, Rushcutters Bay, AU (AU)

(21) Appl. No.: 12/520,766

(22) PCT Filed: Dec. 20, 2007
(86) PCT No.: PCT/AU07/01978

§ 371 Date: Jul. 1, 2010

(30) Foreign Application Priority Data
Dec. 22, 2006 (AU) 2006907159
Mar. 2, 2007 (AU) 2007100170
Mar. 9, 2007 (AU) 2007100204
Mar. 9, 2007 (AU) 2007901244
Mar. 23, 2007 (NZ) 544066
Jun. 1, 2007 (AU) 2007202540
Jun. 4, 2007 (AU) 2007202667

(51) Int. Cl. G06Q 30/00; G06Q 20/00

(52) U.S. Cl. 705/14.14

(57) ABSTRACT

Described herein are methods and systems for conducting sales promotions in accordance with embodiments of the present invention. In some embodiments a retailer offers to consumers an opportunity to win a prize according to predetermined purchasing criteria, this offer being provided as an incentive for the consumers to purchase goods and or services. In overview, and as shown in FIG. (1), a consumer enters into a purchase transaction with a retailer at step (1). In the case that this purchase transaction satisfies predetermined purchasing criteria, an entry in a chance-based gaming activity is defined for the consumer at step (2). This entry is provided to the consumer free of charge. A redemption request is subsequently allowed to be placed in respect of the entry, such a request being received at step (3). Responsive to the redemption request, it is substantially immediately determined whether or not to award a prize to the consumer based on the outcome of the chance-based gaming activity at step (4). The consumer is then substantially immediately informed as to whether or not a prize is to be awarded at step (5).

### FIELD OF THE INVENTION

The present invention relates to method and systems for promoting or enhancing sales. The invention has been developed primarily for use in connection with retail sales and will be described predominantly in this context. It will be appreciated, however, that the invention is not limited to this particular application.

### BACKGROUND TO THE INVENTION

The following discussion of the background art is intended to place the invention in an appropriate context and to enable various associated advantages to be more fully understood. However, any reference to background art throughout the specification should not be construed as an express or implied admission that such background art is widely known or forms part of common general knowledge in the field.

In many types of business, it is known to encourage new and repeat business through the use of “loyalty programs”. Such programs typically make use of a loyalty card or similar identification device. By presenting the card, the consumer is typically entitled to either a discount on the current purchase or an allotment of points that can be applied according to predetermined criteria to discount future purchases. Examples of such programs include “Frequent Flyer” and “FlyBuys” loyalty point programmes. Most banks offer a range of credit card “rewards” programs, which feature bonus partner agreements with various retailers. The terminology for these loyalty and reward programs and others of similar type is used interchangeably throughout this specification and therefore, unless the context dictates otherwise, it should be understood that reference to any one of them, is intended to include reference to others.

Notwithstanding the initial popularity of such programs, there is an increasingly widespread perception that a combination of diminishing points conversion rates, increasing subscription fees, and in the case of frequent-flyer type programs, increasingly stringent capacity and other constraints on the “reward” seats available, has significantly diminished the value to consumers of many loyalty points programmes over time. Furthermore, in order to join most programs of this type, it is necessary to provide the organisation with a significant amount of personal information and many consumers and potential consumers are concerned, notwithstanding current privacy laws, that this information may be used by that organisation or others to target subsequent marketing activities.

Yet another disadvantage is an increasing perception that any benefit likely to be derived from most loyalty programs is built in through a combination of subscription fees and product pricing, and consequently that any net benefit is minimal. In fact, if all accumulated points are not ultimately redeemed, as is often the case for a variety of reasons including administrative inconvenience, overly stringent redemption constraints, expiry of time limits, or simple disinterest, the net financial benefit of participation may actually be negative. This results in large part from a combination of the program cost being effectively built into the product pricing structure, together with the typically significant time delay between accumulation and redemption of loyalty points.

It is an object of the present invention to overcome or ameliorate one or more of the disadvantages of the prior art, or at least to provide a useful alternative.

### SUMMARY

Accordingly, in a first aspect, the invention provides a method for conducting a sales promotion, the method including the steps of:

being responsive to a consumer entering into a purchase transaction with a retailer for selectively defining an entry in a chance-based gaming activity for the consumer in relation to the purchase transaction;

allowing a redemption request to be placed in respect of the entry;

being responsive to the redemption request for substantially immediately determining whether or not to award a prize to the consumer based on the outcome of the chance-based gaming activity;

substantially immediately informing the consumer whether or not a prize is to be awarded.

As used herein, the term “retailer” should be interpreted broadly, as encompassing any person, company, business or other entity that conducts commercial transactions in relation to any form of goods or services, across any media, whether physical or virtual, whether for profit or otherwise. As used herein, the term “consumer” should similarly be interpreted broadly, as encompassing any person, company, business or other entity that enters into a transaction with a retailer. The term “purchase transaction” should be interpreted broadly, as encompassing any transaction between a retailer and a consumer. The goods or services associated with purchase transactions may be of any type, including but not limited to all physical and virtual goods, financial and other business services including banking and broking services, gaining and wagering activities, and the like.

Preferably, in the case that a prize is to be awarded, the prize is substantially immediately awarded to the consumer.

In some embodiments the redemption request is placed at the point for the purchase transaction, and the consumer is substantially immediately informed at the point of sale if a prize is to be awarded. Preferably, where the redemption request is to be placed at the point of sale, the request is placed automatically in response to the entry being defined.

In some embodiments the method includes the step of providing to the consumer a promotional ticket indicative of the entry. This ticket preferably allows the consumer to place the redemption request at a convenient time. Preferably, the ticket is generated in respect of each entry, and is issued substantially immediately to the consumer at the point of sale, as evidence of the associated entry. The ticket may take the form of a card, coupon, voucher, receipt or other suitable medium adapted to carry data indicative of the entry identifier, whether in visual, magnetic, electronic or other form.

Preferably, the method includes the step of offering to one or more consumers an opportunity to win a prize according to predetermined purchasing criteria as an incentive to enter into a purchase transaction. More preferably, the prize offered is predetermined, and is notified to consumers at the point of sale. More preferably, the prize is monetary in nature, and the magnitude of the prize offered is displayed visually in real time at the point of sale.

In one preferred form of the invention, the predetermined purchasing criteria simply constitute a requirement to purchase a particular product, a particular group of products, or a product selected from a particular group. Additionally or alternatively, the predetermined purchasing criteria may include a requirement for the purchase to exceed a predetermined minimum threshold value. Other criteria may optionally include the provision of a predetermined range of consumer data.

The chance-based gaming activity is preferably a lottery style game whereby each entry is associated with one or more entry numbers and the prizes are awarded on the basis of winning numbers drawn or generated at random. In some embodiments the quantity of entry numbers associated with an entry is related to one or more purchase factors. Preferably one or more of the purchase factors is related to the value of the purchase transaction. In one preferred embodiment, as the value of the purchase transaction increases so does the quantity of entry numbers associated with the relevant entry. The general rationale is to offer greater chances of winning to consumers who spend more.

In some preferred embodiments, the gaming activity is initiated in response to the redemption request. For example, the consumer places the redemption request and in response one or more winning numbers are generated to allow the determination of whether or not to award a prize. In other embodiments, the gaming activity is conducted periodically and data indicative of the winning numbers for a given period are made available to allow the determination of whether or not to award a prize.

In one preferred embodiment, the consumer initiates the gaming activity by presenting the promotional ticket to a compatible reader adapted to read the entry identifier carried by that ticket. In alternative embodiments, however, the gaming activity may be initiated by the eligible consumer pulling a lever reminiscent of an early style “poker machine”, or by other suitable means. In some such embodiments this initiation is subject to an approval by the retailer. In yet other embodiments, the gaming activity may be initiated manually by the retailer, or, for example, automatically upon processing of any transaction satisfying the predetermined purchasing criteria.

In one embodiment the redemption request is placed automatically upon the completion of the transaction. For example, in one specific example a transaction completes, redemption occurs substantially immediately, and, in the case that a prize is to be awarded, there is substantially immediately a signal provided (such as flashing lights or a display on a screen) to identify this state of affairs. Preferably this provides a temporal nexus between the transaction and the winning of the prize.

Preferably, the outcome of the gaming activity in terms of a win or no win, and the nature or magnitude of the prize in the event of a win, is displayed substantially immediately on a screen, at the point of sale. This screen may be provided on or adjacent to a POS terminal, or alternately at a location visible from the point of sale. The prize may either be payable on the spot, or subsequently collectable, depending upon the nature and value of the prize and any particular preconditions as may be determined by the operator.

Preferably, the prize is funded by the automatic diversion of a predetermined amount or proportion of the value of the purchase transaction as an entry fee and combining these entry fees into a prize pool. More preferably, this mechanism is not visible to the consumer. Preferably also, in the absence of a winning outcome following any initiation of the gaming activity or “draw”, the prize pool progressively increases or “jackpots”, to enhance the potential winnings in the next draw.

Preferably, the method includes the further steps of combining the entry fees into an entry fee pool, investing at least a proportion of the entry fee pool to generate an investment return, and adding at least a proportion of the investment return to the prize pool.

In one preferred embodiment, the method includes the step of returning to the consumers collectively over time a total value in prizes, which is at least equal in value to the entry fees collectively, by combining at least a proportion of the entry fee pool with at least a proportion of the investment return. It should be appreciated, however, that the steps of investing some or all of the entry fee pool to generate an investment return, and returning some of the investment return to customers through the prize pool or by other means, are optional and do not apply to all embodiments of the invention.

In some embodiments, the entry fee pool includes a plurality of sub-pools, such as a major sub-pool and a minor sub-pool. Prizes are preferably distributed from these sub-pools in accordance with distinct distribution protocols. In one preferred embodiment a plurality of minor prizes are distributed from the minor sub-pool based on a periodic distribution rate. For example, an administrator designates the number and value of minor prizes that are to be distributed during a given period. A single major prize is distributed from the major sub-pool once during a major prize draw period. Preferably this occurs at a randomly selected time during that major prize draw period.

It will be appreciated that the method of the invention may be implemented by a single retailer, to provide a competitive advantage over other retailers in the same market space. However, the invention also lends itself to a linked or networked implementation across a retail franchise or chain, to provide a competitive advantage over other retailers or retail chains. It is also envisaged that the method would, for example, be implemented in a networked form across a variety of retail outlets in a particular shopping centre, strip or mall, to provide a competitive advantage over other centres. Advantageously, such networked implementations allow at least some of the set-up costs to be amortised across multiple sites, and potentially accelerate the accumulation of larger, and therefore more attractive, prize pools.

In a second aspect, the invention provides a system for implementing the method as previously defined, said system including:

at least one computerised terminal adapted to receive entries from consumers satisfying the predetermined purchasing criteria;

a computer processor adapted to receive inputs corresponding to the entries and the respective entry fees from the computerised terminal;

a computer processor adapted to combine the entries and the entry fees to create the prize pool;

a computer processor adapted to generate a random number in response to an initiation control input corresponding to an initiating consumer;

a computer processor adapted to compare the generated random number with a number identifying the entry of the initiating consumer and thereby to determine whether that consumer wins a prize according to predetermined criteria of the gaming activity; and

display means adapted to provide an indication to the initiating consumer at the point of sale whether a prize has been won.

Preferably, the system includes multiple computerised terminals, adapted to receive entries respectively from multiple retail outlets. The terminals are preferably connected to the processors by means of a network, such as a local area network (LAN), a wide area network (WAN), a wired or wireless telecommunications network, the Internet, or successor networks.

Preferably, the system further includes:

a computer processor adapted to invest at least a proportion of the prize pool for a period of time to create an investment return according to predetermined criteria; and

a computer processor adapted to add at least a proportion of the investment return to the prize pool, so as to increase the size of the prize pool.

Preferably, one or more of the computer processors are communicatively connectable to a financial services computer system associated with a financial services provider. In one preferred embodiment, the connectable computer processor is adapted to communicate data indicative of the proportion of the prize pool to be invested to the financial services computer system. In a particularly preferred embodiment, the connectable processor is adapted to:

receive said inputs over a predetermined time period;

extract from each of the inputs corresponding individual entry fees;

perform a running summation of said individual entry fees so as to calculate an investment pool amount as received within said time period; and

at or near the conclusion of said time period, to communicate said investment pool amount to the financial services computer system.

In one preferred form of the invention, the method and system provide the option to each consumer of a paid discount, refund or rebate of a predetermined amount or a predetermined proportion of the nominal purchase price, in return for the consumer foregoing the opportunity to participate in the chance-based gaming activity. More preferably, the discount, refund or rebate corresponds in value to the amount that would otherwise be contributed to the prize pool on behalf of that consumer.

In a third aspect, the invention provides a method for providing a sales promotion, the method including the steps of:

(a) accepting transaction data indicative of a purchase transaction between a consumer and a retailer;

(b) being responsive to the transaction data for selectively defusing an entry identifier corresponding to the purchase transaction;

(c) providing data indicative of the entry identifier;

(d) accepting a redemption request, the redemption request being indicative of the entry identifier;

(e) being responsive to the redemption request for determining whether or not to award a prize;

(f) providing data indicative of whether or not a prize is to be awarded.

In some embodiments steps (a) to (c) are preformed at least in part at a first terminal, and steps (d) to (f) are performed at least in part at a second terminal. In some embodiments, steps (a) to (f) are performed at least in part by a central server in communication with one or more terminals.

Preferably the method includes the steps of associating in a database the entry identifier with one or more entry numbers. Determining whether or not to award a prize preferably involves determining whether or not one of these numbers is identified as a winning number by a lottery style game whereby winning numbers are drawn or generated at random. In some embodiments, the quantity of entry numbers associated with the entry identifier is selected responsive to the transaction data. In one preferred form the quantity of entry numbers associated with the entry identifier is selected responsive to the value of the transaction. More preferably the quantity of entry numbers is proportional to the value of the transaction.

Preferably, an entry identifier is defined only in the case that the purchase transaction satisfies one or more predetermined purchasing criteria. In one preferred form of the invention, the predetermined purchasing criteria simply constitute a requirement to purchase a particular product, a particular group of products, or a product selected from a particular group. Additionally or alternatively, the predetermined purchasing criteria may include a requirement for the purchase to exceed a predetermined minimum threshold value. Other criteria may optionally include the provision of a predetermined range of consumer data.

Preferably the method includes the step of being responsive to the transaction data for providing data indicative of an entry fee. More preferably, the entry fee is a predetermined proportion of the transaction value. Also preferably, this entry fee is added to a prize pool.

In some preferred embodiments, the providing of data indicative of the entry identifier at step (c) includes providing a signal indicative on an instruction to print a promotional ticket carrying the entry identifier. In other embodiments, the providing of data indicative of the entry identifier at step (c) includes automatically placing a redemption request.

In a fourth aspect, the invention provides computer-readable carrier media carrying a set of instructions that when executed by one or more processors cause the one or more processors to perform a method for providing a sales promotion, the method including the steps of:

(a) accepting transaction data indicative of a purchase transaction between a consumer and a retailer;

(b) being responsive to the transaction data for selectively defining an entry identifier corresponding to the purchase transaction;

(c) providing data indicative of the entry identifier;

(d) accepting a redemption request, the redemption request being indicative of the entry identifier;

(e) being responsive to the redemption request for determining whether or not to award a prize;

(f) providing data indicative of whether or not a prize is to be awarded.

In one preferred embodiment, the carrier media includes a medium bearing a propagated signal detectable by at least one processor of the one or more processors and representing the set of instructions. In one embodiment, the carrier media includes a carrier wave bearing a propagated signal detectable by at least one processor of the one or more processors and representing the set of instructions a propagated signal and representing the set of instructions. In one embodiment, the carrier media includes a transmission medium in a network bearing a propagated signal detectable by at least one processor of the one or more processors and representing the set of instructions.

In a further aspect, the invention provides a system for conducting a sales promotion including:

a first processor that is responsive to a consumer entering into a purchase transaction with a retailer for selectively defining an entry in a chance-based gaming activity for the consumer in relation to the purchase transaction;

a second processor for allowing a redemption request to be placed in respect of the entry;

a third processor responsive to the redemption request for substantially immediately determining whether or not to award a prize to the consumer based on the outcome of the chance-based gaming activity;

a fourth processor for substantially immediately informing the consumer whether or not a prize is to be awarded.

In some embodiments a single processor defines two or more of the first, second, third and fourth processors.

In a further aspect, the invention provides a method of sales promotion including the steps of:

offering consumers a substantially immediate opportunity to win a prize according to predetermined purchasing criteria as an incentive to purchase;

generating an entry attributable to each consumer in respect of each purchase satisfying the predetermined purchasing criteria;

conducting a chance-based gaming activity to determine at point of sale whether each entry wins a prize; and

distributing prizes to consumers associated with any winning entries.

In a further aspect, the invention provides a method for conducting a sales promotion, the method including the steps of:

being responsive to a consumer entering into a purchase transaction with a retailer for selectively defining an entry in a chance-based gaming activity for the consumer in relation to the purchase transaction, the purchase transaction having a transaction value and being for goods and/or services unrelated to the chance-based gaming activity;

in the case that an entry is defined, being responsive to one or more characteristics of the purchase transaction for determining a portion of the transaction value for addition to a prize pool, the prize pool for maintaining portions of transaction values of a plurality of other purchase transactions in relation to which respective entries have been defined;

allowing a redemption request to be placed in respect of the entry at either or both of the time of completion of the retail transaction and a time selected by the consumer;

being responsive to the redemption request for substantially immediately determining whether or not to award a prize to the consumer based on the outcome of the chance-based gaming activity, wherein the prize is defined by a portion of the prize pool; and

substantially immediately informing the consumer whether or not a prize is to be awarded.

In some embodiments, the portion of the transaction value for addition to the prize pool is “for addition to the prize pool” in a purely notional sense. That is, there is no actual funds transfer from the transaction itself. In some embodiments, the approach implemented is to keep a record of the notional portions and to provide a retailer with information as to the quantum of the retailer's funds that should be diverted to the prize pool. As such, the prize pool is not in a strict sense directly funded by the transactions. Rather, the prize pool is funded by the retailer, and the quantum of the prize pool is determined based on the transaction values and/or other characteristics of the transaction.

In some embodiments the portion of the transaction value for addition to the prize pool is related to the quantum of the transaction value. For example, the portion is calculated as a proportion of the total transaction value. However, this is not the case across all embodiments. For example, in other embodiments the relevant portion of the transaction value is predetermined irrespective of the transaction value, such as a fixed amount that is common across all transactions. In some embodiments the portion is determined with some consideration of other characteristics of the transaction, such as the goods and/or services involved in the transaction value, or one or more characteristics of the consumer.

As an example, in one embodiment, a manufacturer, Manufacturer X, agrees to provide provides $Y to the prize pool for every one of Manufacturer X's products sold. In this case, the portion is or includes $Y for each transaction for goods including one of Manufacturer X's products. To add an additional intricacy, a retailer, Retailer A, has agreed to provide B % of the transaction value $T to the prize pool for each transaction. In the event that a consumer enters into a purchase transaction for goods including one of Manufacturer X's products, the total transaction value being $T, the portion of the transaction value determined for addition to the prize pool is $Y plus B % of $T. In practice, the $Y is provided to the prize pool by Manufacturer X, and the B % of $T is provided to the prize pool by Retailer A.

In a similar example, Manufacturer X agrees to provide to the prize pool Y % of the total spent on Manufacturer X's products. Retailer A, agrees to provide to the prize pool $B for each transaction. In the event that a consumer enters into a purchase transaction for goods including $Z of Manufacturer X's products, the portion of the transaction value determined for addition to the prize pool is X % of $Z plus $B. In practice, the X % of $Z is provided to the prize pool by Manufacturer X, and the $A is provided to the prize pool by Retailer A.

In one embodiment at least a portion of the prize pool is temporarily subjected to an investment procedure for the generation of investment income and subsequently returned to the prize pool, at least portion of the investment income being added to the prize pool. For example, in a preferred embodiment where the prize pool includes a major sub-pool and minor sub-pool, only one of these sub-pools is subjected to the investment procedure.

In a further aspect, the invention provides a method for conducting a sales promotion, the method including the steps of:

being responsive to a consumer entering into a purchase transaction with a retailer for selectively defining an entry in a chance-based gaming activity for the consumer in relation to the purchase transaction;

providing a prize pool for funding one or more prizes in relation to the chance-based gaming activity;

subjecting at least a portion of the prize pool to an investment procedure for the generation of investment income and subsequently returning this portion to the prize pool;

adding at least portion of the investment income to the prize pool;

allowing a redemption request to be placed in respect of the entry;

being responsive to the redemption request for substantially immediately determining whether or not to award a prize to the consumer based on the outcome of the chance-based gaming activity, wherein the prize is defined by a portion of the prize pool; and

substantially immediately informing the consumer whether or not a prize is to be awarded.

In one embodiment the method includes the step of, in the case that an entry is defined, being responsive to one or more characteristics of the purchase transaction for determining a portion of the transaction value for addition to the prize pool, the prize pool for maintaining portions of transaction values of a plurality of other purchase transactions in relation to which respective entries have been defined.

In a further aspect, the invention provides a method for conducting a sales promotion, the method including the steps of:

providing a prize pool for funding one or more prizes in relation to a chance-based gaming activity, the prize pool including at least a portion of the transaction value of a plurality of purchase transactions made by a plurality of consumers;

subjecting at least a portion of the prize pool to an investment procedure for the generation of investment income and subsequently returning this portion to the prize pool;

adding at least portion of the investment income to the prize pool; and

selectively distributing some or all of the prize pool amongst one or more of the consumers based on the outcome of the chance-based gaming activity.

In a further aspect, the invention provides a system for conducting a sales promotion, the system including:

a first interface for receiving data indicative of a purchase transaction between a consumer and a retailer, the purchase transaction having a transaction value;

a first processor that is responsive to the first interface for selectively defining an entry in a chance-based gaming activity for the consumer in relation to the purchase transaction, wherein the purchase transaction is for goods and/or services unrelated to the chance-based gaming activity;

a second processor for, in the case that an entry is defined, being responsive to one or more characteristics of the purchase transaction for determining a portion of the transaction value for addition to a prize pool, the prize pool for maintaining portions of transaction values of a plurality of other purchase transactions in relation to which respective entries have been defined;

a second interface for receiving data indicative of a redemption request placed in respect of the entry at either or both of the time of completion of the retail transaction and a time selected by the consumer;

a third processor that is responsive to the redemption request for substantially immediately determining whether or not to award a prize to the consumer based on the outcome of the chance-based gaming activity, wherein the prize is defined by a portion of the prize pool; and

a third interface for providing a signal to substantially immediately inform the consumer whether or not a prize is to be awarded.

The term “interface” as used herein should be read broadly to include substantially any component capable of providing or receiving digital and/or analogue signals. This may include either or both of a hardware interface (such as a Ethernet interface, serial communications interface, wireless interface, or other communications interface) or a software-based interface.

A further aspect of the invention provides a computer-readable carrier medium carrying a set of instructions that when executed by one or more processors cause the one or more processors to perform a method of conducting a sales promotion, the method including the steps of:
(a) receiving data indicative of a purchase transaction between a consumer and a retailer, the purchase transaction having a transaction value;
(b) providing a signal indicative of the purchase transaction to administration subsystem, wherein the subsystem is configured for:
   (i) being responsive to the signal indicative of the purchase transaction for selectively defining an entry in a chance-based gaming activity for the consumer in relation to the purchase transaction and, wherein the purchase transaction is for goods and/or services unrelated to the chance-based gaming activity;
   (ii) in the case than an entry is defined, providing a first return signal indicative of the entry;
   (iii) in the case than an entry is defined, being responsive to the signal for determining a portion of the transaction value for addition to a prize pool, the prize pool for maintaining portions of transaction values of a plurality of other purchase transactions in relation to which respective entries have been defined;
(c) receiving data indicative of a redemption request placed in respect of the entry at either or both of the time of completion of the retail transaction and a time selected by the consumer;
(d) providing a signal indicative of the redemption request to the administration subsystem, the administration subsystem being responsive to the signal indicative of the redemption request for substantially immediately determining whether or not to award a prize to the consumer based on the outcome of the chance-based gaming activity and providing a second return signal indicative of whether or not to award a prize, wherein the prize is defined by a portion of the prize pool; and
(e) being responsive to the second return signal for providing a further signal to substantially immediately inform the consumer whether or not a prize is to be awarded.

In one preferred form the one or more processors are provided by a POS terminal having a coupon printer and a barcode scanner. Preferably, in response to the first return signal, an instruction to print a coupon carrying a barcode indicative of the entry is provided to the coupon printer. Preferably, in response to this instruction, the barcode indicative of the entry is printed on a coupon that is also a receipt for the purchase transaction. In this preferred form, the step of receiving data indicative of a redemption request includes receiving data indicative of the barcode from a barcode scanner coupled to the one or more processors. For example, the receipt is scanned at a barcode scanner conventionally used for scanning goods for sale, and this scanning initiates the redemption process.

In some embodiments the administration subsystem includes the one or more processors. For example, the administration subsystem may be coupled to or integrated with the POS terminal.

A further aspect of the invention provides a system for conducting a sales promotion, the system including:

a first subsystem for providing a prize pool for funding one or more prizes in relation to a chance-based gaming activity, the prize pool including at least a portion of the transaction value of a plurality of purchase transactions made by a plurality of consumers;

a second subsystem for subjecting at least a portion of the prize pool to an investment procedure for the generation of investment income and subsequently returning this portion to the prize pool and for adding at least portion of the investment income to the prize pool; and

a third subsystem for selectively distributing some or all of the prize pool amongst one or more of the consumers based on the outcome of the chance-based gaming activity.

A further aspect of the invention provides a system for conducting a sales promotion, the system including:

a first interface for receiving data indicative of a one or more characteristics of a purchase transaction between a consumer and a retailer;

a first processor responsive to one or more characteristics of the purchase transaction for selectively defining an entry in a chance-based gaming activity for the consumer in relation to the purchase transaction, wherein the purchase transaction is for goods and/or services unrelated to the chance-based gaming activity;

a second processor responsive to one or more characteristics of the purchase transaction for defining entry parameters for the entry, wherein the entry parameters affect at least one of

(i) the probability of the consumer winning a prize; or

(ii) a characteristic of a prize winnable by the consumer;

a second interface for receiving data indicative of a redemption request placed in respect of the entry at either or both of a time of completion of the retail transaction and a time selected by the consumer;

a third processor responsive to the redemption request for substantially immediately determining whether or not to award a prize to the consumer based on the outcome of the chance-based gaming activity; and

a third interface for providing a signal to substantially immediately inform the consumer whether or not a prize is to be awarded.

In various embodiments, the characteristics of the purchase transaction may include, but are not limited to, one or more of the following:
the transaction value;
a payment method used in the transaction;
the type, brand, nature or some other attribute of goods or services, or categories of goods or services, involved in the transaction;
the time of the transaction;
the location of the transaction;
the provision of supplementary information or documentation by the consumer;
data indicative of previous or concurrent participation in designated loyalty or rewards schemes;
the mode of interaction between the consumer and the retailer;
any other characteristics of the transaction, or a party to the transaction.

Preferably, defining entry parameters for the entry includes assigning one or more chances to the entry. The number of chances assigned to the entry is preferably related to one or more characteristics of the purchase transaction. Furthermore, in such cases, the probability of the consumer winning a prize is typically related to the number of chances assigned to that entry.

In some preferred forms, defining the entry parameters for the entry includes selecting one or more of a plurality of prize classes for association with the entry. Each prize class preferably defines one or more winnable prizes, and more preferably the selection of one or more prize classes is based on one or more characteristics of the purchase transaction.

In some embodiments the system is responsive to the data indicative of the purchase transaction for selectively modifying the magnitude of the prize winnable by the consumer.

In some embodiments, each purchase transaction increases the magnitude of the prize winnable by that consumer and all subsequent consumers until the prize has been won, in a manner analogous to a jackpotting prize pool. In other embodiments, however, each purchase transaction may only modify the magnitude or nature of the prize winnable by that particular consumer, on the basis of some characteristic of that specific purchase transaction.

A further aspect of the invention provides computer-readable carrier medium carrying a set of instructions that when executed by one or more processors cause the one or more processors to perform a method of conducting a sales promotion, the method including the steps of:

receiving data indicative of a purchase transaction between a consumer and a retailer, the purchase transaction having a transaction value;

being responsive to one or more characteristics of the purchase transaction for selectively defining an entry in a chance-based gaming activity for the consumer in relation to the purchase transaction, wherein the purchase transaction is for goods and/or services unrelated to the chance-based gaming activity;

being responsive to one or more characteristics of the purchase transaction for defining entry parameters for the entry, wherein the entry parameters affect at least one of:

(i) the probability of the entry winning a prize; or

(ii) a characteristic of the prize winnable on the basis of the entry;

receiving data indicative of a redemption request placed in respect of the entry at either or both of the time of completion of the retail transaction and a time selected by the consumer;

being responsive to the redemption request for substantially immediately determining whether or not to award a prize to the consumer based on the outcome of the chance-based gaming activity; and

providing a signal to substantially immediately inform the consumer whether or not a prize is to be awarded.

In some embodiments the carrier medium includes a medium bearing a propagated signal detectable by at least one processor of the one or more processors and representing the set of instructions.

In some embodiments the carrier medium includes a carrier wave bearing a propagated signal detectable by at least one processor of the one or more processors and representing the set of instructions a propagated signal and representing the set of instructions.

In some embodiments the carrier medium includes a transmission medium in a network bearing a propagated signal detectable by at least one processor of the one or more processors and representing the set of instructions.

One embodiment provides a method for conducting a sales promotion, the method including:

receiving data indicative of a purchase transaction between a consumer and a retailer, the purchase transaction having a transaction value;

being responsive to the data for selectively defining an entry in a chance-based gaming activity for the consumer in relation to the purchase transaction, wherein the purchase transaction is for goods and/or services unrelated to the chance-based gaming activity;

processing the data to determine a supplementary contribution amount for the consumer; and

providing a prize pool from which prizes are to be awarded in relation to the change-based gaming activity, wherein the prize pool is funded at least in part by a value corresponding to the supplementary contribution amount.

One embodiment provides a method including the step of:

in the case that an entry is defined, being responsive to one or more characteristics of the purchase transaction for determining a consumer direct contribution amount, wherein the prize pool is additionally funded at least in part by a value corresponding to the consumer direct contribution amount.

One embodiment provides a method wherein the consumer direct contribution is determined to be a proportion of the transaction value.

One embodiment provides a method wherein the supplementary contribution includes a net investment return derived from the investment of the transaction amount.

One embodiment provides a method wherein the supplementary contribution includes a net investment return derived from the investment of a proportion of the transaction amount.

One embodiment provides a method wherein the supplementary contribution includes a net investment return derived from the investment of a value corresponding to the consumer direct contribution.

One embodiment provides a method wherein the supplementary contribution includes a net distribution marketing amount.

One embodiment provides a method wherein the net distribution marketing amount is derived from a gross distribution marketing amount provided by a third party in consideration for marketing material being provided to the consumer in connection with the purchase transaction.

One embodiment provides a method wherein the marketing material is printed on a transaction receipt for the purchase transaction.

One embodiment provides a method wherein the supplementary contribution includes a net collection marketing amount.

One embodiment provides a method wherein the net collection marketing amount is derived from a gross collection marketing amount provided by a third party in consideration to marketing information being obtained in relation to the consumer in connection with the purchase transaction.

One embodiment provides a method wherein the supplementary contribution amount affects the relative probability of the consumer winning a prize based on his/her respective entry.

One embodiment provides a method wherein the supplementary contribution amount affects a characteristic of a prize winnable by the consumer based on his/her respective entry.

One embodiment provides a method including the steps of:

receiving data indicative of a redemption request placed in respect of the entry at either or both of the time of completion of the retail transaction and a time selected by the consumer;

being is responsive to the redemption request for substantially immediately determining whether or not to award a prize to the consumer based on the outcome of the chance-based gaming activity, wherein the prize is defined by a portion of the prize pool.

One embodiment provides a method including the step of processing data associated with the redemption request for selectively attributing an additional supplementary contribution to the consumer.

One embodiment provides a method including the step of substantially immediately informing the consumer whether or not a prize is to be awarded.

One embodiment provides a method for providing a prize pool for a sales promotion, the method including the steps of:

receiving data indicative of an instruction to transfer funds corresponding to a transaction value for a purchase transaction between a consumer and a retailer from a consumer account to a retailer account;

providing the funds to a third location for a predefined period to derive a gross investment return including a supplementary contribution amount for the consumer;

at the end of the predefined period, transferring the funds to the second location; and

adding a value corresponding to the supplementary contribution amount to the prize pool.

One embodiment provides a method for conducting a sales promotion, the method including:

receiving data indicative of a purchase transaction between a consumer and a retailer, wherein the consumer is provided with marketing material in connection with the purchase transaction;

being responsive to the data for selectively defining an entry in a chance-based gaming activity for the consumer in relation to the purchase transaction, wherein the purchase transaction is for goods and/or services unrelated to the chance-based gaming activity;

processing the data to determine a supplementary contribution amount for the consumer, the supplementary contribution amount including a net distribution marketing amount related to the provision of the marketing material to the consumer; and

providing a prize pool from which prizes are to be awarded in relation to the change-based gaming activity, wherein the prize pool is funded at least in part by a value corresponding to the supplementary contribution amount.

One embodiment provides a method wherein the marketing material is printed on a transaction receipt for the purchase transaction.

One embodiment provides a method for providing a prize pool for funding one or more prizes in respect of a chance-based gaming activity, the method including the steps of:

receiving data indicative of an instruction to transfer funds from a first location to a second location in settlement of a purchase transaction;

providing the funds to a third location for a predefined period to derive a gross investment return;

at the end of the predefined period, transferring the funds to the second location; and

on the basis of the gross investment return, adding a value corresponding to a net investment return to the prize pool.

One embodiment provides a method wherein the chance-based gaming activity is provided for a method for conducting a sales promotion according to claim 1.

One embodiment provides a method for conducting a sales promotion, the method including:

receiving data indicative of a purchase transaction between a consumer and a retailer, the purchase transaction having a transaction value;

being responsive to the data for selectively defining an entry in a chance-based gaming activity for the consumer in relation to the purchase transaction, wherein the purchase transaction is for goods and/or services unrelated to the chance-based gaming activity; and

providing a prize pool from which prizes are to be awarded in relation to the change-based gaming activity, wherein the prize pool has a predetermined maximum value, and a variable available value, wherein the available value varies based on consumer behaviour.

One embodiment provides a method including the steps of:

being responsive to the transaction value for determining a variation amount for the available value; and

increasing the available value by the available amount.

One embodiment provides a method including the step of identifying a jackpot event and, responsive to the jackpot event, reducing the available value to a baseline level.

One embodiment provides a method wherein the jackpot event occurs prior to the available value reaching a predefined maximum.

One embodiment provides a method wherein the probability of the jackpot event occurring increases as the available value approaches the predefined maximum.

One embodiment provides a computer program product for carrying out a method as described above.

One embodiment provides a computer-readable carrier medium carrying a set of instructions that when executed by one or more processors cause the one or more processors to perform a method as described above.

One embodiment provides a computer system including a processor configured to perform a method as described above.

### BRIEF DESCRIPTION OF THE DRAWINGS

Preferred embodiments of the invention will now be described, by way of example only, with reference to the accompanying drawings in which:

FIG. 1 illustrates a method of conducting a sales promotion according to an embodiment of the present invention;

FIG. 2 schematically illustrates a system for conducting a sales promotion according to an embodiment of the present invention;

FIG. 2A schematically illustrates a system for conducting a sales promotion according to an embodiment of the present invention;

FIG. 3 illustrates a method of conducting a sales promotion according to an embodiment of the present invention;

FIG. 4 illustrates a method of conducting a sales promotion according to an embodiment of the present invention;

FIG. 5 illustrates a method of conducting a sales promotion according to an embodiment of the present invention;

FIG. 6 schematically illustrates an aspect of a sales promotion according to an embodiment of the present invention;

FIG. 6A schematically illustrates an aspect of a sales promotion according to an embodiment of the present invention;

FIG. 6B schematically illustrates an aspect of a sales promotion according to an embodiment of the present invention;

FIG. 7 illustrates a method of conducting a sales promotion according to an embodiment of the present invention;

FIG. 8 schematically illustrates an aspect of a sales promotion according to an embodiment of the present invention;

FIG. 9 schematically illustrates a system for conducting a sales promotion according to an embodiment of the present invention;

FIG. 9A schematically illustrates a system for conducting a sales promotion according to an embodiment of the present invention;

FIG. 9B schematically illustrates a system for conducting a sales promotion according to an embodiment of the present invention;

FIG. 10A schematically illustrates an aspect of a sales promotion according to an embodiment of the present invention;

FIG. 10B schematically illustrates an aspect of a sales promotion according to an embodiment of the present invention;

FIG. 11 schematically illustrates a system for conducting a sales promotion according to an embodiment of the present invention;

FIG. 12 schematically illustrates a method for conducting a sales promotion according to an embodiment of the present invention; and

FIG. 13 schematically illustrates a method for conducting a sales promotion according to an embodiment of the present invention.

### DETAILED DESCRIPTION

### Overview

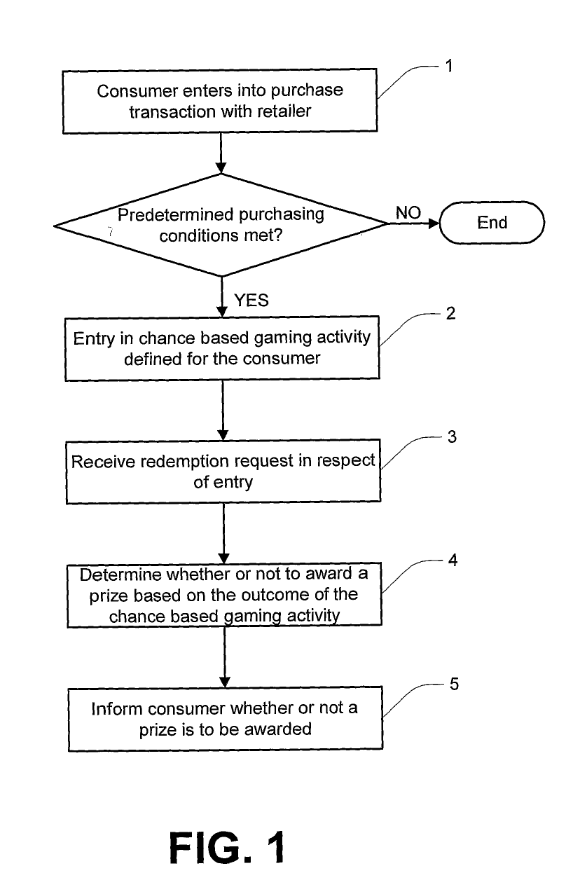

Described herein are methods and systems for conducting sales promotions in accordance with preferred embodiments of the invention. In some embodiments a retailer offers to consumers an opportunity to win a prize according to predetermined purchasing criteria, this offer being provided as an incentive for the consumers to purchase goods and or services. In overview, and as shown in FIG. 1, a consumer enters into a purchase transaction with a retailer at step 1. In the case that this purchase transaction satisfies predetermined purchasing criteria, an entry in a chance-based gaming activity is defined for the consumer at step 2. This entry is provided to the consumer free of charge. A redemption request is subsequently allowed to be placed in respect of the entry, such a request being received at step 3. Responsive to the redemption request, it is substantially immediately determined whether or not to award a prize to the consumer based on the outcome of the chance-based gaming activity at step 4. The consumer is then substantially immediately informed as to whether or not a prize is to be awarded at step 5.

Typically, the purchase transaction is for goods and/or services unrelated to the chance-based gaming activity. That is, the consumer is not simply purchasing one or more entries in the chance-based gaming activity—these entries are awarded as a side effect of the purchase transaction.

### Exemplary Hardware Arrangement

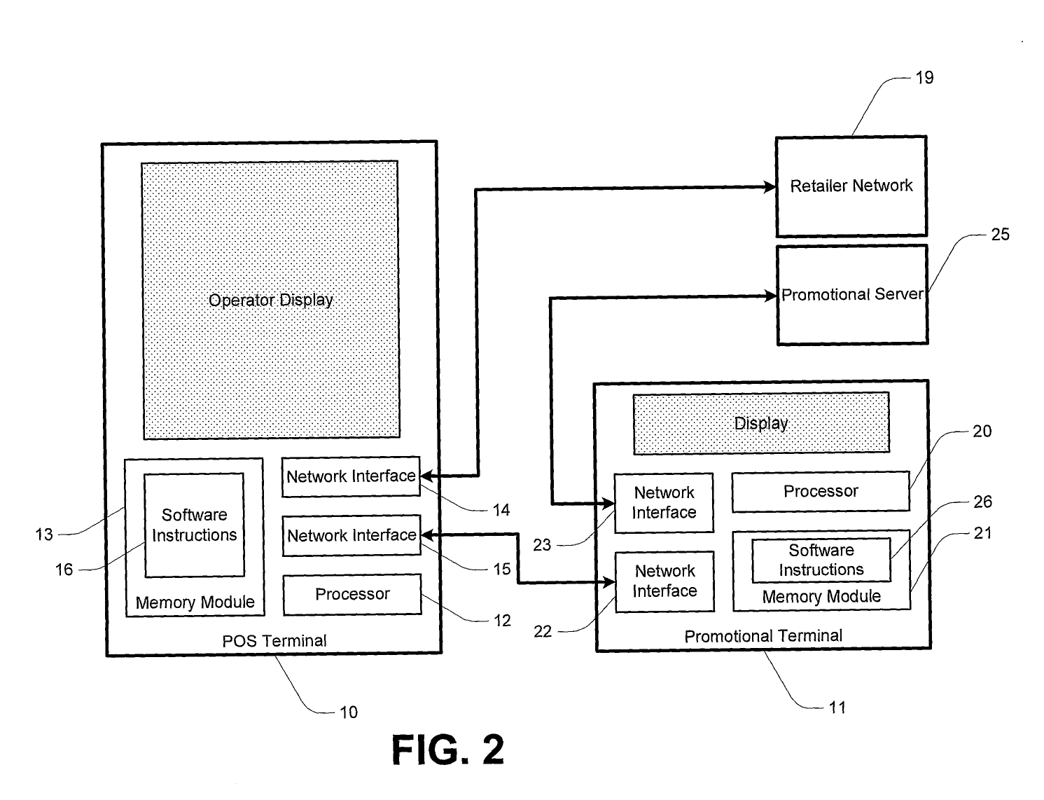

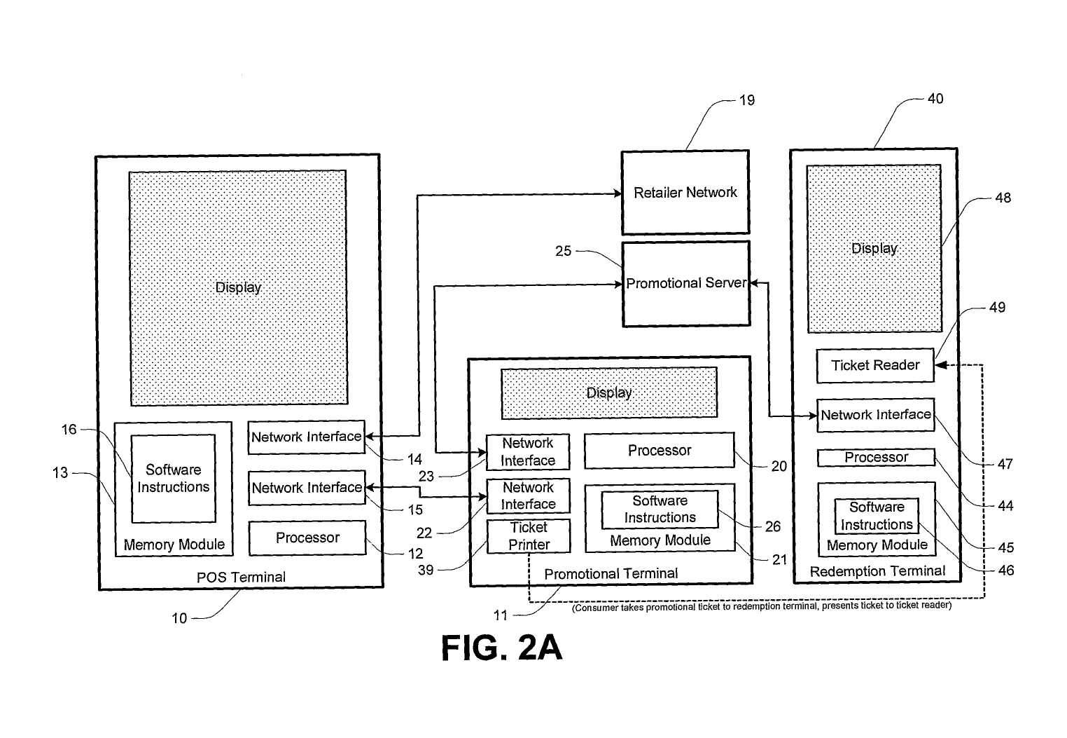

FIG. 2 illustrates an exemplary hardware arrangement for implementing the sales promotion of FIG. 1. In this embodiment, a Point of Sale (POS) terminal 10 operates in conjunction with a promotional terminal 11. A POS operator uses the POS terminal 10 substantially in the conventional manner. That is, upon a consumer offering to purchase goods and or services, the POS operator interacts with the terminal to complete a purchase transaction in the context of an electronic sales management system. This typically includes the POS operator providing input indicative of either or both of the nature of goods being purchased and the price of goods being purchased, and subsequently accepting from the consumer cash or electronic payment.

As illustrated, the POS terminal 10 includes a processor 12 coupled to a memory module 13, a first a network interface 14 and a second network interface 16. The memory module 13 carries software instructions 16, these instructions allowing a POS software package to execute on the POS terminal. The first network interface 14 optionally couples the POS terminal to a retailer network 19 administered by the retailer, for example a network on which inventory and sales management applications are maintained and executed. The second network interface 15 couples the POS terminal to the promotional terminal 11. Although these two network interfaces are described as individual interfaces, in practice they are typically defined by a single hardware component such as an Ethernet port.

The promotional terminal 11 includes a processor 20 coupled to a memory module 21, a first network interface 22, and a second network interface 23. Again, although these two network interfaces are described as individual interfaces, in practice they are typically defined by a single hardware component. However, from a conceptual perspective, the network interface 22 couples the promotional terminal 11 to the POS terminal 10 whilst the network interface 23 couples the promotional terminal 11 to a promotional server 25. The memory module 21 carries software instructions 26 that allow the promotional terminal 11 to perform various methods of conducting a sales promotion according to embodiments of the present invention. Some such methods are discussed below.

Although the promotional server 25 is treated herein as a discrete unit, in practice it may be defined by one or more networked computational platforms each having one or more respective processors and associated memory units.

Although in the embodiment of FIG. 2 the POS terminal 10 is coupled to the promotional terminal 11 by way of network interfaces, in other embodiments a peripheral connection is used as an alternative. Additionally, in some further embodiments various components of the promotional terminal 11 are integrated with POS terminal 10. For example, in one embodiment software instructions 26 are carried by memory module 14 and operate to affect the manner in which an existing POS software package operates.

### Exemplary Integrated Entry Allocation/Redemption Process

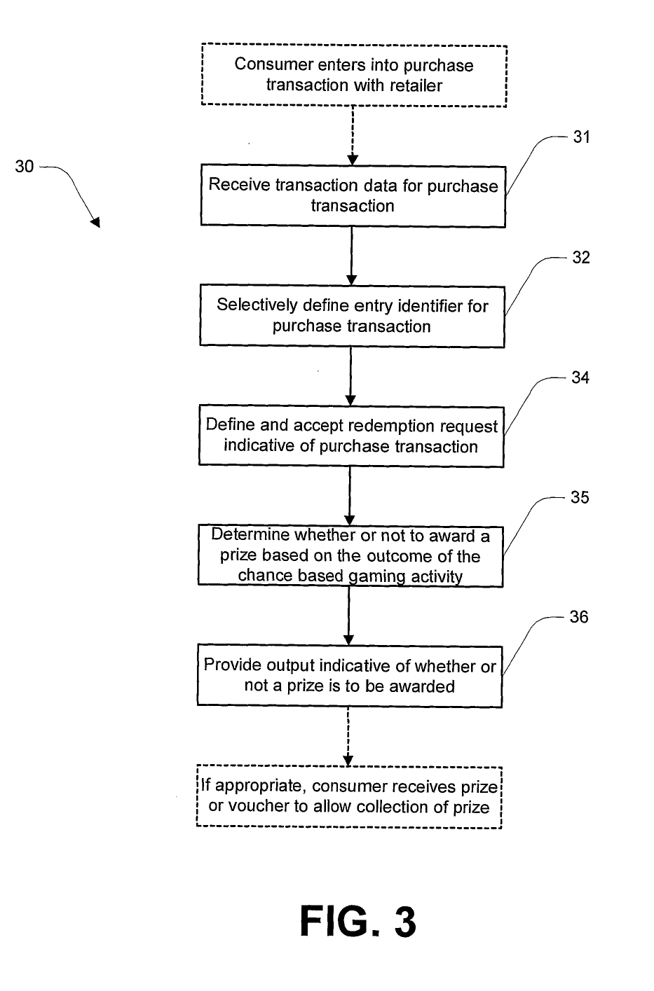

In some embodiments the consumer informed as to whether or not a prize is to be awarded at the point of sale, both from a location and temporal perspective. That is, the consumer is informed as to whether or not a prize is to be awarded substantially immediately following the completion of the purchase transaction. FIG. 3 illustrates a method 30 carried out on the basis of software instructions 26 in such an embodiment. At step 31 the promotional terminal 11 accepts as input transaction data indicative of a purchase transaction between a consumer and a retailer. In the present embodiment the POS terminal software instructions 16 cause the POS terminal 10 to provide this transaction data to promotional terminal 11—for example by way of a software patch applied to an existing POS software package. In another embodiment the promotional terminal 11 actively obtains this transaction data—for example by monitoring the operation of and/or communications involving the POS terminal.

Various methods described herein are representative of processes executed on the basis of software instructions. In the figures, these methods are shown in conjunction with related external steps, such as steps carried out by human users. These external steps are shown in dashed lines, and provided for the sake of illustration only. They should not be regarded as limiting, as the relevant processes may execute in absence of these specific external steps.

The transaction data accepted at step 31 includes data indicative of the transaction value, and in some embodiments additional information such as the nature of the purchased goods. In the present embodiment the POS terminal 10 provides transaction data only for transactions that meet predefined purchasing criteria. In some embodiments these criteria include any one or more of the following:
The purchase transaction exceeding a minimum threshold value.
The purchase transaction involving payment by one of a predetermined selection of prescribed payment methods. For example, it may be required that payment be by way of cash, by way of credit card, or by way of a credit card issued by a specific authority.
The purchase transaction relating to a particular product, a particular group of products, or a product selected from a particular group.
The provision of a predetermined range of consumer data at the time of the purchase transaction. For example, this may hinge on the willingness of the consumer to participate in a market research exercise.

In another embodiment the POS terminal 10 provides transaction data for all transactions, and whether or not each transaction meets the predefined purchasing criteria is determined at the promotional terminal 11 following step 31.

At step 32 the promotional terminal 11 is responsive to the transaction data for selectively defining an entry identifier corresponding to the purchase transaction. In some embodiments this identifier is defined locally at the promotional terminal 11, however in other embodiments step 32 includes providing a signal to the promotional server 25 indicative of an instruction to define an entry identifier. At step 34 the promotional terminal 11 defines a redemption request being indicative of the entry identifier, this request being effectively accepted as input. At step 35 the promotional terminal 11 is responsive to the redemption request for determining whether or not to award a prize. This step is discussed in some more detail further below. At step 36 the promotional terminal 11 provides, as output, data indicative of whether or not a prize is to be awarded. This is preferably communicated by way of a visual display observable by the consumer, however in some embodiments is communicated only to the operator of the POS console. In either case, whether or not a prize is to be awarded is determined and communicated substantially immediately at the point of sale.

In an alternate embodiment steps 32 to 35 are carried out at the promotional server 25 in response to a signal from the promotional terminal 11.

There are advantages associated with determining whether or not a prize is to be awarded at substantially the same time as a purchase transaction is completed. For example, the substantially instantaneous nature of the prize determination renders the promotion particularly user friendly and effort free for the consumer. Additionally, there is a close nexus between the receipt of a prize and the purchase of goods.

### Exemplary Distributed Entry Allocation/Redemption Arrangement

In another embodiment, whether or not a prize is to be awarded is determined at a time selected by the consumer. One such example is provided by FIG. 2A, which illustrates a redemption terminal 40 in conjunction with the PUS terminal 10 and a promotional terminal 11. Although this redemption terminal is presently illustrated as discrete from the promotional terminal, in some embodiments the redemption terminal and promotional terminal are integrated into a single composite unit.

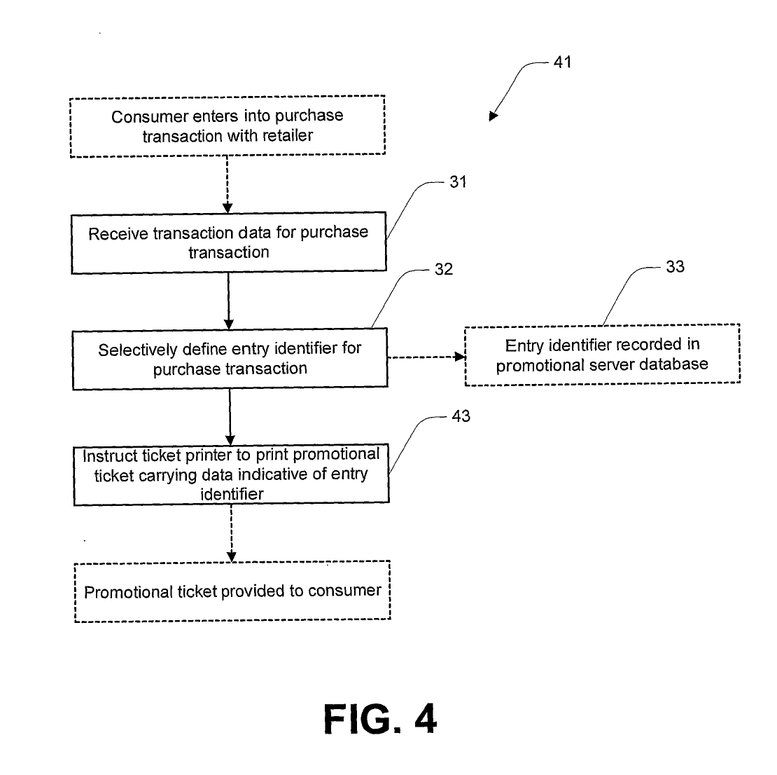

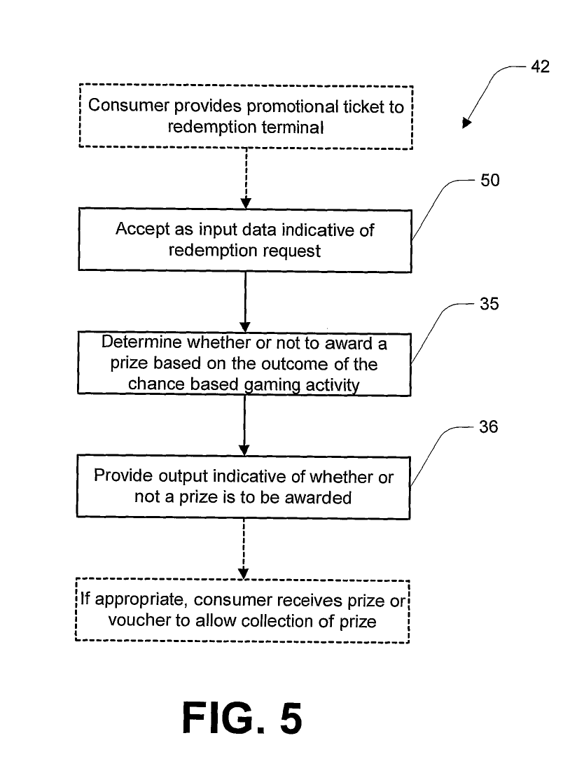

In the embodiment of FIG. 2A, the promotional terminal 11 includes a ticket printer 39 for printing a promotional ticket indicative of an entry, this ticket carrying data indicative of the relevant entry identifier. This is discussed in more detail below by reference to the methods 41 and 42 shown in FIGS. 4 and 5 respectively. In some alternate embodiments the ticket printer is an external device serially or peripherally coupled to the redemption terminal.

The method 41 of FIG. 4 is carried out on the basis of software instructions 26 in one embodiment where the hardware arrangement of FIG. 2A is implemented. This method includes steps 31 and 32, and a further step 33 at which the defined entry identifier is recorded in a database maintained by the promotional server 25. This step 33 is typically conducted at the promotional server 25, and as such is shown in dashed lines. Following or substantially at the same time as step 33 there is a step 43 which includes providing an instruction to the ticket printer 39 print a promotional ticket carrying data indicative of the relevant entry identifier. This ticket is subsequently printed at the point of sale, and provided to the consumer. The consumer holds this promotional ticket as evidence of an entry in the sales promotion.

The nature of the promotional ticket varies between embodiments. For example, the ticket may take the form of a card, coupon, voucher, receipt or other The ticket may take the form of a card, coupon, voucher, receipt or other suitable medium adapted to carry data indicative of the entry identifier, whether in visual, magnetic, electronic or other form.

As illustrated in FIG. 2A, the redemption terminal 40 includes a processor 44 coupled to a memory module 45, network interface 47, display unit 48 and ticket reader 49. In overview, the memory module 45 carries software instructions 46 that allow for the execution of the method 42 of FIG. 4, which is discussed below. The network interface 47 couples the redemption terminal 40 to the promotional server 25. The display unit 48 is used to inform a user (typically a consumer) whether or not a prize is to be awarded by providing visual information. The ticket reader 49 is used to extract the entry identifier from the promotional ticket. The nature of the ticket reader 49 corresponds with the nature of the promotional ticket to allow reading of the entry identifier from the ticket. For example, in one embodiment the promotional ticket is a paper substrate that carries a barcode indicative of the entry identifier, and the redemption terminal includes a complementary barcode reader.

Referring to FIG. 5, the method 42 commences at 50 with the receipt of a redemption request. In this embodiment, the redemption request is made by a user (typically a consumer) by interfacing a promotional ticket with the ticket reader 49. The method then progresses steps 35 and 36 described above, noting that in this embodiment these steps are carried out at the redemption terminal based on software instructions 46, and step 36 includes providing visual output by way of the display unit 48 to inform the user of the redemption terminal 40 whether or not a prize is to be awarded.

Where a prize is to be awarded, the redemption terminal 40 awards this prize to the consumer. As was the case before, in some embodiments this involves providing the prize itself (for example in the form of currency notes), and in other embodiments this involves providing a voucher to facilitate collection of the prize from an identified party.

There are various advantages associated with performing prize determination at a time selected by the consumer. These advantages include:
The ability to make use of space on the promotional tickets for the carriage of marketing information. This space may be sold to provide income for an administrator of the sales promotion or to cover the costs associated with the running of the sales promotion.
Increased consumer interaction resulting from the utilisation of the redemption terminal. This terminal optionally operates in a manner to encourage usage—for example by providing an enticing user interface. In some embodiments this user interface gives a user the impression that a game of chance is being carried out during step 35, for example by providing the semblance of a gaming machine. This is in spite of the fact that the actual game of chance upon which prize determination is based may have been carried out previously, or a game of chance having an outcome unrelated to the activity being displayed to the user. In one embodiment the redemption terminal includes a lever reminiscent of an early style “poker machine” to further encourage consumer interaction.
The ability to provide consumers with the ability to exercise some control over their chances of winning a prize. For example, in one embodiment the prize is a monetary prize awarded as a jackpot from a prize pool that increases over time. The value of the prize pool is displayed to consumers—for example by way of a jackpot display as is common in traditional gaming venues. It is advertised to consumers that the jackpot will be awarded prior to the prize pool reaching an identified maximum value, and as such consumers may wish to delay redemption until the prize pool approaches that value to maximise their chances of winning. This may have a side effect of retaining consumers in a retail location for an extended period of time.
The ability to increase business exposure by selection of the relative location of the promotional terminal with respect to the redemption terminal. In one embodiment, where a plurality of retailers use similar promotional terminals and similar redemption terminals for a common sales promotion, the redemption terminal of a first retailer is configured to accept only promotional tickets from a second retailer. This provides cross-promotion whereby consumers are encouraged to visit more than one of the retailers offering the sales promotion.

In some embodiments rather than physically printing a promotional ticket at the promotional terminal 11, alternate techniques are used to provide the consumer with a portable entry identifier. For example, the entry identifier is associated by the promotional terminal and at the promotional server with another identifier carried by the consumer. This may be a physically carried identifier such as a loyalty card, conventional pre-existing credit card, or the like. It may alternatively be a mentally carried identifier, such as the persons name, email address, or personal access code.

### Exemplary Prize Allocation Process

As foreshadowed, in the methods above step 35 includes being responsive to the redemption request for determining whether or not to award a prize. There are a number of approaches implemented in the various embodiments for conducting this determination, and indeed for conducting the game of chance upon which this determination is based. A few of these prize determination approaches are discussed below.

For the prize determination approaches described herein, the entry identifier is typically associated in the database of the promotional server 25 with one or more entry numbers which may or may not include the entry identifier itself. Determining whether or not to award a prize preferably includes determining whether or not one of these entry numbers is the same as a winning number by lottery style game whereby winning are numbers drawn or generated at by random selection.

It will be appreciated that, although the present embodiments are described by reference to entry numbers and a lottery style game, in other embodiments alternate selection mechanisms are used. To this end the term “entry numbers” should be read broadly to describe individual opportunities to win in a broader context. In the described embodiments it may be assumed that each entry number is a discrete single or multi digit number, however in other embodiments an entry number is defined by a string of individual numbers much like a convention lottery entry.

In the present embodiments, the more entry numbers associated with a given entry identifier, the greater the chances of that entry identifier winning a prize at the time of redemption. In some embodiments the quantity of entry numbers associated with the entry identifier is selected responsive to the transaction data. In some embodiments the quantity of entry numbers associated with an entry identifier is selected responsive to the value of the relevant transaction. In one such embodiment the quantity of entry numbers is proportional to the value of the transaction. For example, an entry identifier is added for each five dollars of the purchase transaction value. The general rationale is to encourage increased spending by proving greater chances of winning a prize to those consumers who spend more. In another embodiment additional numbers are associated with an entry identifier if a particular preselected product or service is purchased, thereby to encourage the purchase of that product or service.

In some alternate embodiments an entry is associated with only one entry number, and this entry number is the entry identifier.

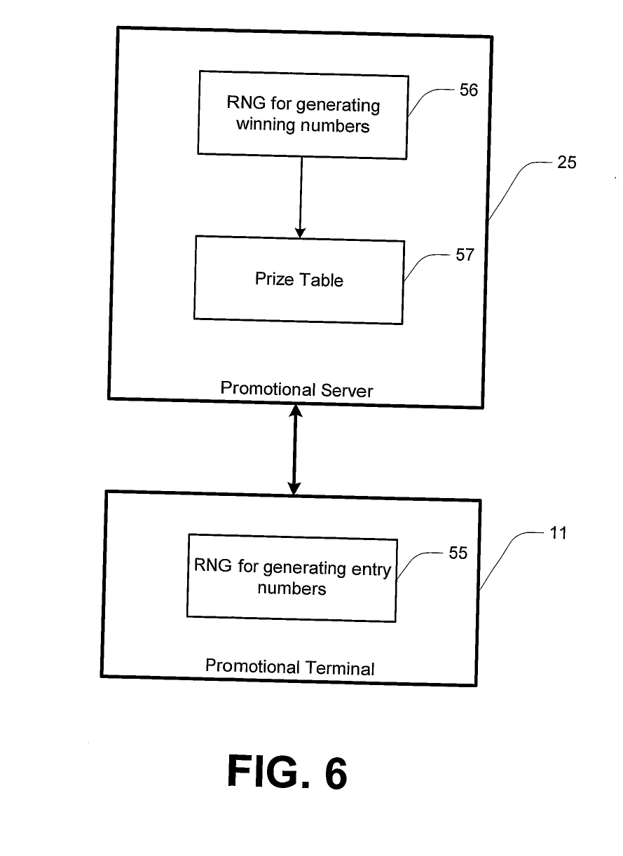

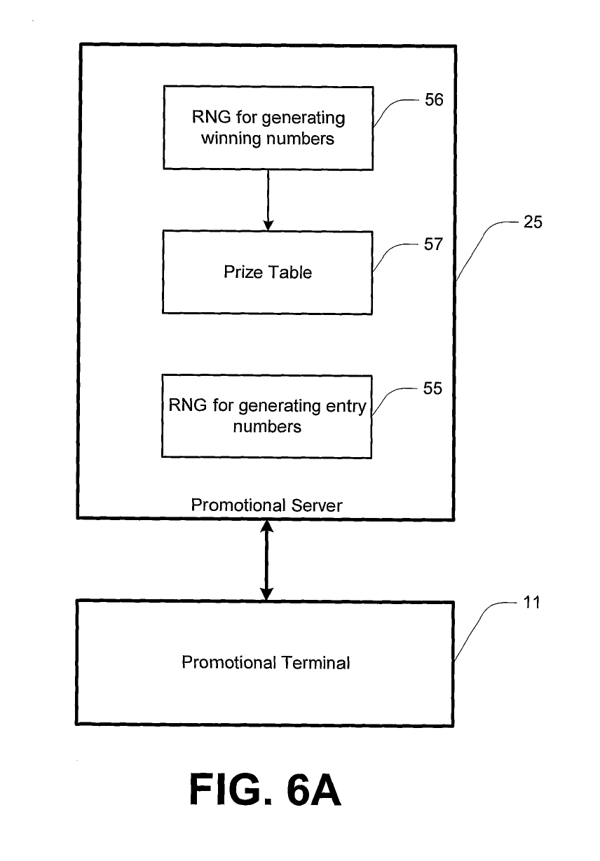

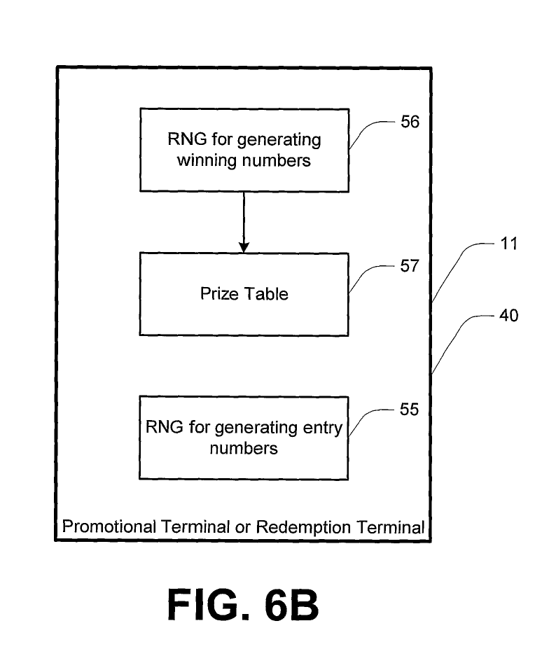

A prize determination approach is illustrated in FIG. 6, where two random number generators (RNGs) 55 and 56 are used. The first RNG 55 is responsible for generating one or more entry numbers for association with an entry identifier. This first RNG 55 is, in the context of FIG. 6, provided by software instructions executing on either of the promotional terminal 11, however in other embodiments the RNG 55 executes on the promotional server 25 as shown in FIG. 6A. The second RND 56 executes on the promotional server 25 generate numbers for a prize table 57. In simple terms, if an entry number corresponds to a number in the prize table, that entry number is a winning entry number. In the embodiment of FIG. 6B both RNGs executes on either of the promotional terminal 11 and the redemption terminal 40.

In some embodiments where promotional tickets are used, the or each of the entry numbers corresponding to an entry are printed on a promotional ticket and the prize table 57 made available to consumers by way of a display screen. This allows consumers to optionally determine whether or not they have won a prize without needing to place a redemption request.

In some embodiments the first RND 55 and the second RNG 56 generate numbers from within a like range. By such an approach there is no guarantee that a winning number will be generated, in which case no prize is awarded and there may be a jackpot of the prize pool. In other embodiments the second RNG 56 generates only numbers known to have been previously generated by the first RND 55 during a predefined period. For example, the game of chance is conducted each hour and numbers are randomly generated from the selection of entry numbers generated over the previous hour.

The RNGs described herein are not in all embodiments “random” in a strict technical sense. For example, in certain preferred embodiments an RNG is driven by a controllable algorithm that is dynamically variable to maintain a predetermined prize allocation profile or particular “return to player” characteristics. For example, the algorithm is adjusted to better ensure that a prize is reliably awarded to a predetermined proportion of participating consumers, or to ensure that a prize is reliably awarded within predetermined time or operational constraints.

In some embodiments the prize table is structured, and identifies numbers for different levels of prize are to be awarded. For example, at one level a major cash prize is awarded, at another level a minor cash prize is awarded, and at another level a promotional voucher is awarded. In one embodiment this is based on a pyramid structure whereby a larger number of lesser value prizes are awarded at lower levels, and a smaller number of greater value prizes are awarded at higher levels. In other embodiments the prize table is unstructured, and each number in the prize table corresponds to a like level of prize. In one such embodiment the prize table includes only a single number.

### Exemplary Redemption Processes

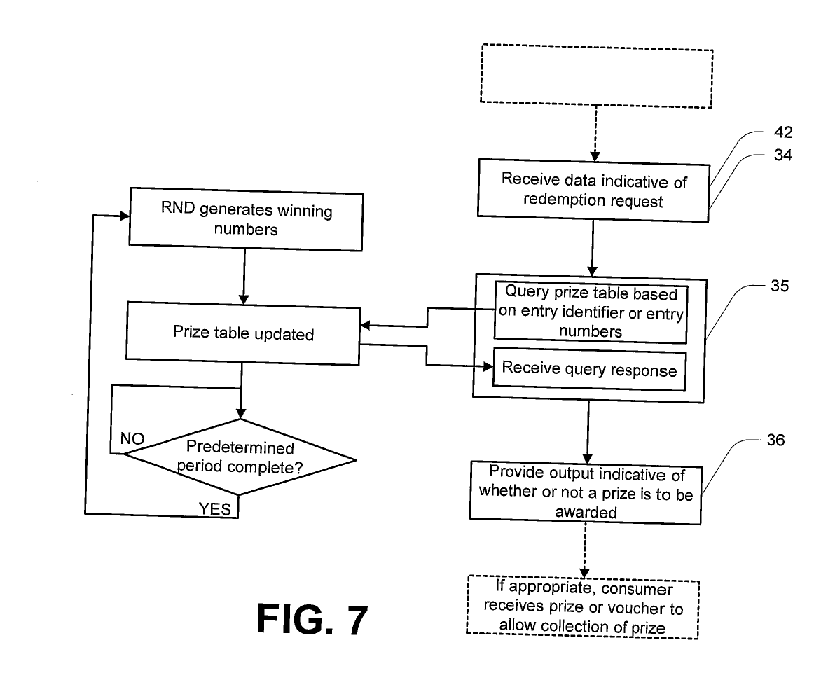

FIG. 7 illustrates an exemplary redemption determination method where the prize table 57 is generated periodically, for example hourly, daily, weekly, or upon a certain prize being won. In overview, a redemption request is placed on the basis of an entry identifier, and the current prize table queried on the basis of the entry number or numbers associated with the that entry identifier. The query may be submitted to a master version of the prize table maintained at the promotional server, or submitted to a copy of the prize table stored locally at either the promotional terminal or redemption terminal at which the redemption request initiates. A prize is awarded in the case that one or more of the entry numbers correspond to one or more numbers in the prize table.

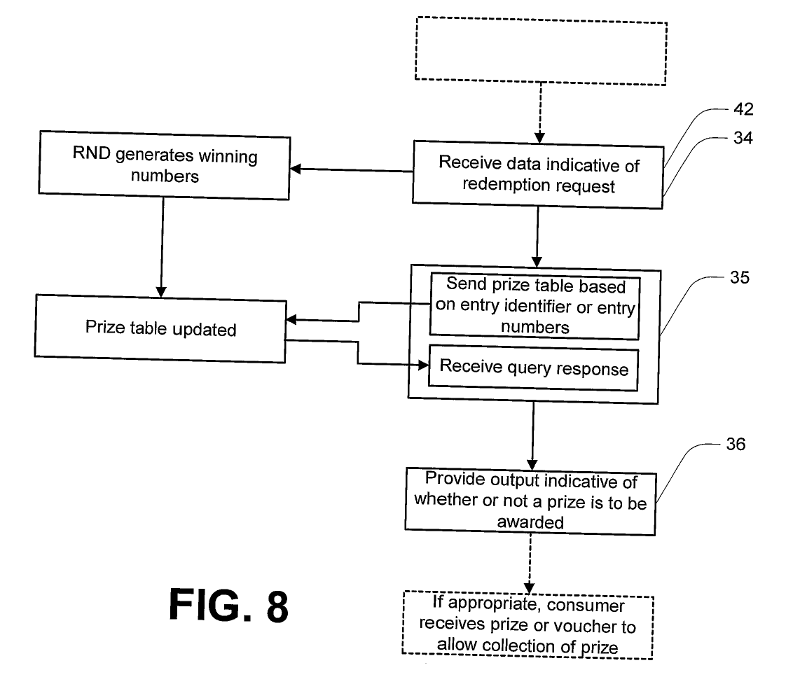

A second exemplary redemption determination method is illustrated in FIG. 8. This approach involves conducting the game of in response to the placement of a redemption request. In one embodiment an RNG 56 executes on the promotional server 25. This RNG 56 is responsive to the placement of a redemption request for generating one or more numbers to define the prize table 57. This prize table is queried based on the number of numbers associated with the relevant entry identifier, and subsequently discarded

A general premise of some of the embodiments discussed above is that entry numbers are generated at the point of sale. In some alternate embodiments where promotional tickets are used these entry numbers are instead defined responsive to a redemption request at the redemption terminal 40. In one such embodiment this removes the need for coupling of the promotional terminal 11 and the promotional server 25. For example, the entry identifier is simply an alphanumeric string that is validated by the redemption terminal to determine whether a promotional ticket is valid. In the case that the ticket is valid, the redemption terminal arranges for the generation of entry numbers for association with that entry identifier. These entry numbers are then queried against an existing or purpose generated prize table 57.

### Cross-Promotional Aspects

Although the above examples have generally been described in terms of a single retailer, in other embodiments a plurality of retailers participate in a common sales promotion. Examples of this include:
A single retailer with a number of individual outlets, these outlets being operated by either or both of the retailer or franchisees of a brand identifying the retailer. The outlets may be distributed across a town, state, country or even internationally.
A group of retailers who have agreed to participate in a common sales promotion administered by a sales promotion service provider. Outlets operated by these retailers again may be distributed across a town, state, country or even internationally.
A group of retailers whose respective outlets are located in a common area, such as a shopping mall, airport, or the like. In some cases this area is common by location (for example a single shopping mall), and in some cases this area is common by nature (for example a chain of shopping malls having a common owner). It will be appreciated that such a model is not only used to provide a competitive advantage to the retailers, but also to the common area in a broader context.

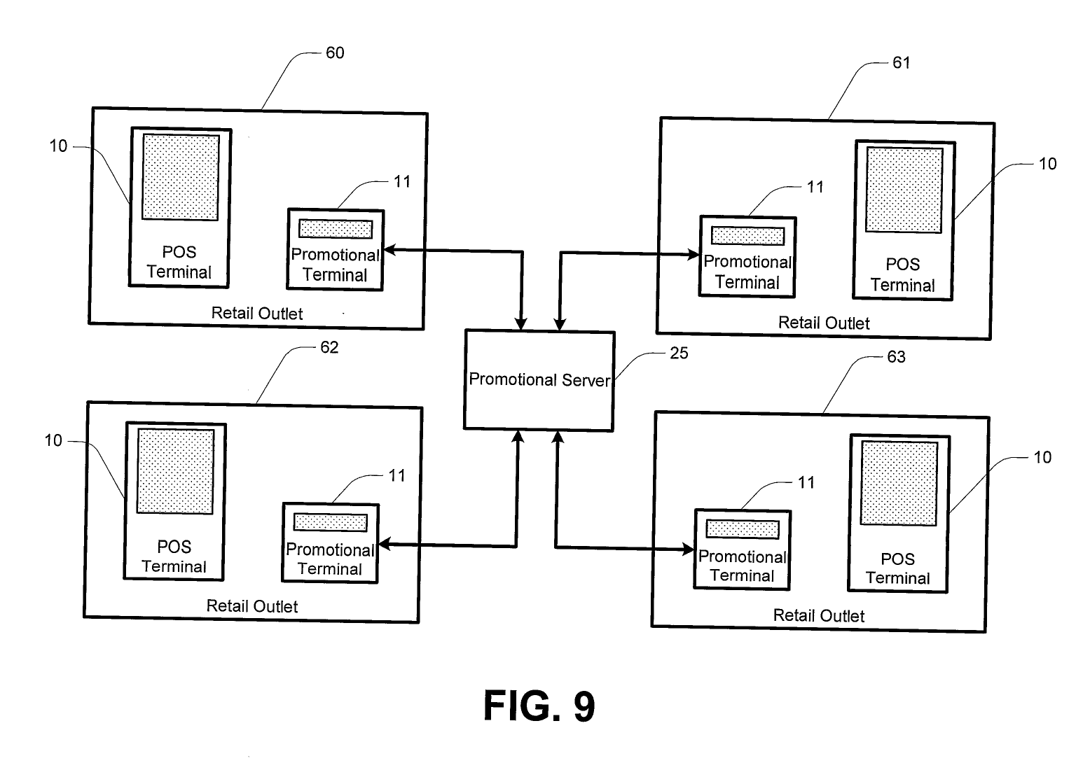

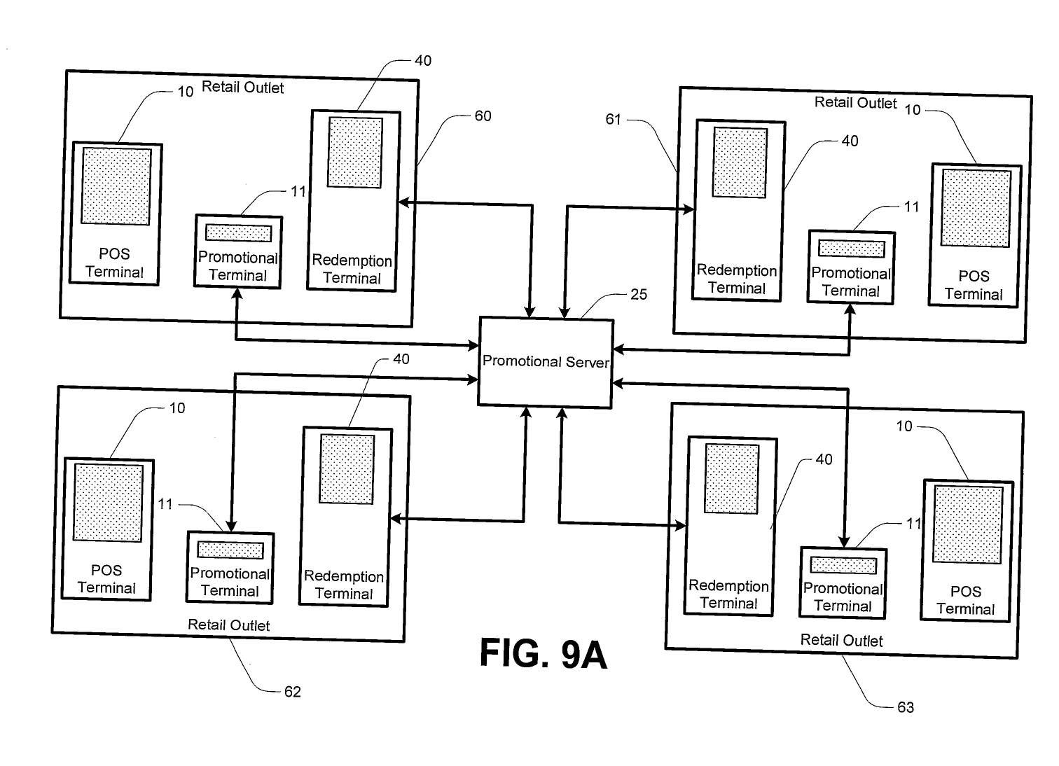

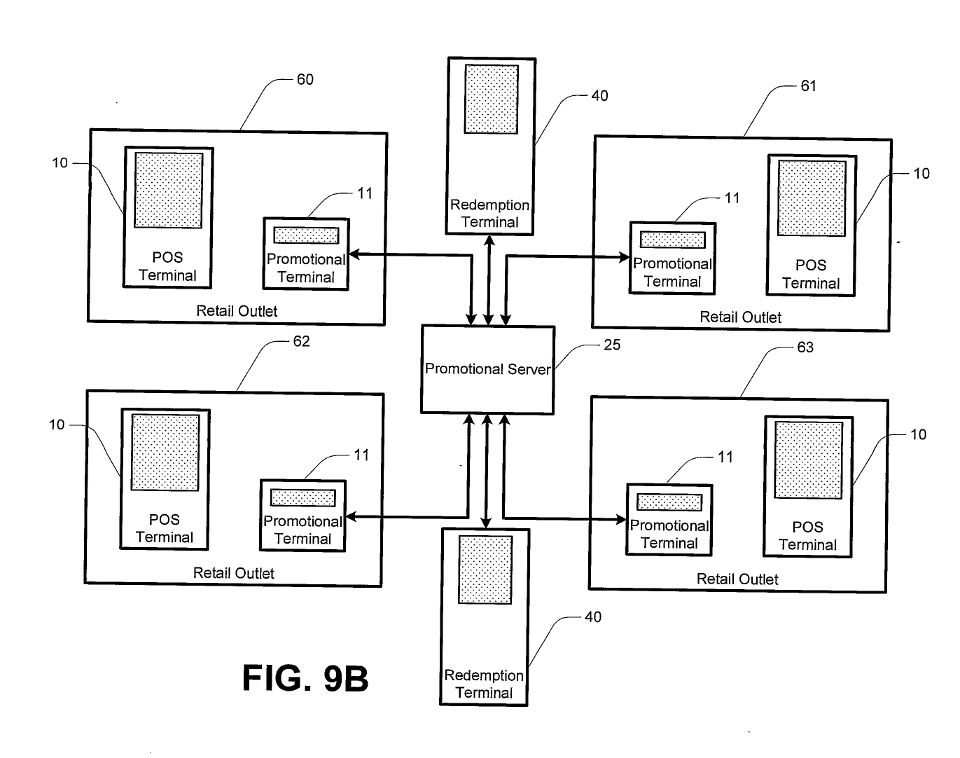

FIGS. 9, 9A and 9B each illustrate a sales promotion being carried out at a plurality of retail outlets.

In the example of FIG. 9 a setup similar to that of FIG. 2 is used at each outlet, and each outlet 60 to 63 has a respective promotional terminal 11 coupled to a POS terminal 10. All of the promotional terminals 11 are coupled to a common promotional server 25.

In the example of FIG. 9A a setup similar to that of FIG. 2A is used at each outlet, and each outlet 60 to 63 has a respective promotional terminal 11 coupled to a POS terminal 10, and additionally has a redemption terminal 40. All of the promotional terminals 11 and redemption terminals 40 are coupled to a common promotional server 25.

The example of FIG. 9B also makes use to a similar setup as FIG. 2A, however the promotional terminals 40 are located away from the individual outlets, and there is not necessarily a one-to-one relationship between promotional terminals and redemption terminals. In on practical example the promotion is conducted in a shopping mall, with the promotional terminals existing adjacent respective POS terminals, and a lesser number of redemption terminals are provided in common areas of the shopping mall.

Common to the examples of FIGS. 9, 9A and 9B is the utilization of a single promotional server 25. The individual terminals may be coupled to this server by way of LAN or WAN connection, although it is often preferable to use the Internet or another wide area communications link—particularly in embodiments where the retailers are geographically spaced apart across a large area. Other communications means may also be used, including wired or wireless telecommunications networks.

### Prize Pool Generation

In some embodiments along the lines of FIGS. 9, 9A and 9B, prizes are funded by a central prize pool. Whilst this prize pool is not always entirely monetary in nature (i.e. it may include non-monetary prizes, such as goods and/or services), it can be considered as having a value, and therefore requires funding of one form or another. The manner by which the prize pool is funded varies between embodiments, and in some cases includes either or both of the following:
Direct funding. One or more parties provide respective amounts (monetary or otherwise) to the prize pool. For example, a retailer involved in the promotion contributes a predetermined sum of money. This is advantageous in the sense that the liability of each party in respect of the prize pool is known in advance, and as such it is possible to make an upfront cost/benefit analysis.
Consumer contribution based funding. A contribution to the prize pool may result from the consumer entering into a transaction with a retailer. This consumer contribution includes two components: a direct consumer contribution (see, for example transaction based funding below) and a supplementary contribution (also discussed further below). In some embodiments one of these components may be zero (i.e. there is only a direct consumer contribution or a supplementary contribution).

In some embodiments the prize pool is funded by both of these approaches. For example, direct funding is used to provide a baseline prize pool, and consumer contribution based funding (including direct consumer contribution and/or supplementary contribution) is used to supplement this prize pool, thereby to allow it to increase over time. In other embodiments only one of direct funding and consumer contribution based funding is present.

The term “pool” is intended to be given the broadest possible interpretation, covering the physical pooling of bets, entry fees or other value components into a single deposit account or other investment product, as well as the virtual pooling of such components across multiple accounts or multiple investment products, whether those components are deposited simultaneously or at different times, and whether those components are invested over the same or different timeframes.

In some embodiments the prize pool includes a plurality of sub-pools, such as a major sub-pool and a minor sub-pool. Prizes are preferably distributed from these sub-pools in accordance with distinct distribution protocols. In one preferred embodiment a plurality of minor prizes are distributed from the minor sub-pool based on a periodic distribution rate. For example, an administrator designates the number and value of minor prizes that are to be distributed during a given period. A single major prize is distributed from the major sub-pool once during a major prize draw period, which may be a matter of days, weeks, or months. Preferably this occurs at a randomly selected time during that major prize draw period.

In one specific embodiment, minor prizes are awarded in accordance with a daily distribution rate such that a consistent number of prizes are awarded each day. On the other hand, the major prize is awarded only once a week. In the event that the major prize is awarded early in the week, consumers may in practice choose to delay redeeming their entries until the next week. It will be appreciated that this may encourage repeat business.

### Direct Funding Ramifications

In some embodiments, multiple retailers participate in a given promotion, these retailers providing respective direct funding amounts, which vary in magnitude. In one example, Retailer A contributes 20% of the prize pool, whilst Retailer B contributes 40% of the prize pool. In some such embodiments, the probability of a consumer winning a prize based on an entry resulting from a transaction with one of these retailers varies in a manner related to the retailers' relative contributions to the prize pool. For example, in the example of Retailer A and Retailer B, it may be that an entry resulting from a transaction with Retailer B has twice the relative probability of winning a prize as compared with an entry resulting from a transaction with Retailer B, all else being equal.

In some embodiments, the prize pool is additionally or alternately funded by providers of goods and/or services, and consumers have a higher relative probability of winning a prize in respect of retail transactions involving goods and/or services from suppliers who make a relatively larger contribution to the prize pool.

### Consumer Contribution Based Funding

In some embodiments, the prize pool is funded in whole or in part by way of consumer contributions. The general notion is that, as a result of a purchase transaction (or other interaction involving the consumer, such as a redemption request), a contribution might be made to the prize pool. As noted, consumer contributions include either or both of direct consumer contributions and supplementary contributions. Direct consumer contributions are essentially a portion of the consideration provided by the consumer (i.e. a portion of the transaction value), or an amount corresponding to that portion. In other words, by purchasing goods and/or services, the consumer makes a direct consumer contribution to the prize pool. This is discussed further in the context of transaction based funding below. In the context of supplementary contributions, rather than funds provided by a consumer directly funding a prize pool, an amount realized by virtue of the consumer's actions is used to fund the prize pool. The precise manner in which supplementary contribution is defined varies between embodiments, and the scope of the present disclosure should not necessarily be limited by any specific definition. The supplementary contribution for a given consumer in some embodiments includes components having values corresponding to:
A net investment return derived from the investment of the transaction amount, or a portion of the transaction amount, or another sum of money (see section entitled prize pool generation via investment return).
A net distribution marketing amount. For example, a third party provides a gaming operator with a gross distribution marketing amount (such as currency or goods/services) in consideration for marketing information being provided to a consumer (for example, this marketing information may be communicated at the point of sale and/or at the time of redemption, conveyed on a receipt, etc). Of this gross distribution marketing amount, a net distribution marketing amount provides a component of the consumer's supplementary contribution amount. In some cases a consumer is able to increase his/her net distribution marketing amount by receiving further marketing material—for example by viewing electronic advertisements. This may result in a benefit to the consumer (see relationship between contribution and gaining activity below).
A net collection marketing amount. This is similar to the example considered above, however is derived by collecting information from consumers, such as personal information or opinion information. For example, in some cases a third party provides a gaming operator with a gross collection marketing amount (such as currency or goods/services) in consideration for marketing information being obtained from a consumer. In some cases obtaining this information includes conducting a survey at the point of sale or at the time of redemption. In other cases it involves collecting demographic and other objective information, such as goods/services purchased, time of purchase, and so on.

It will be appreciated that a given consumer's supplementary contribution amount is, in strict physical terms, provided by a party other than the consumer. However, on the basis that the supplementary contribution arises from the consumer's behaviour, it is able to be attributed to the consumer.

There is discussion in the above examples of “gross” amounts and “net” amounts. The terms “gross” and “net” are used in a descriptive sense only. In particular, the term “gross” refers to an amount derived by the gaming operator, and the term “net” refers to an amount that is attributable to the supplementary contribution amount. In some cases the net amount is the corresponding gross amount less any applicable taxes, levies or operator charges. In other cases there is no direct nexus between the gross and net amounts.

### Transaction Based Funding

In this example, the total value of the prize pool is not predetermined. Rather, the value of the prize pool increases over time, which is optionally achieved by diverting to the prize pool a portion of the transaction value for each purchase transaction resulting in the generation of an entry. This will be recognized as a direct consumer contribution.

In some cases about 1% of the transaction value for each transaction is diverted to the prize pool. It will be appreciated that the use of low percentages (less than about 5%) should have little effect on the price of goods or profit margins of retailers. However, assuming there are enough transactions and participants, the prize pool can grow relatively quickly. In some embodiments the percentages are tiered such that a lesser percentage is payable on more expensive transactions. In some embodiments a flat rate is diverted per transaction rather than a percentage of the purchase price.

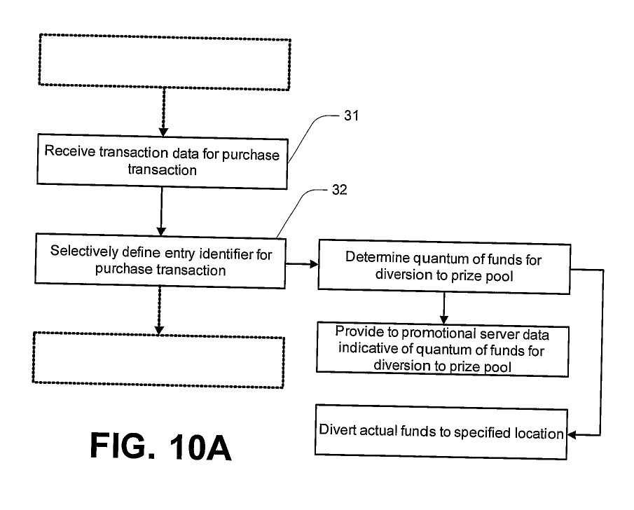

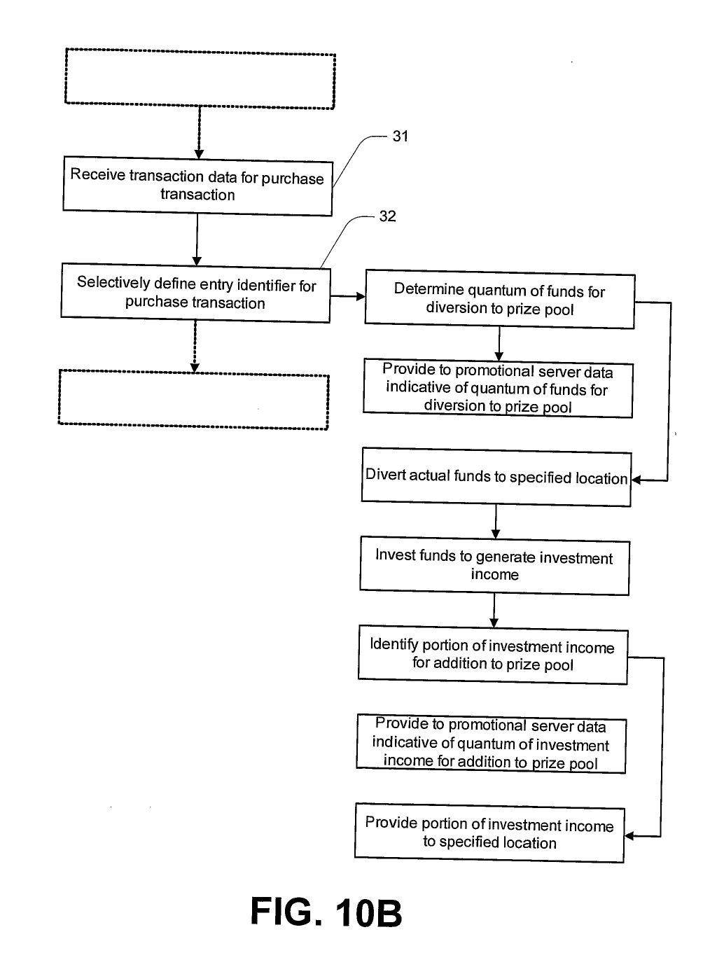

Calculating the amount of funds to be diverted is typically carried out on the basis of software instructions 26 executing on the promotional terminal 11 in response to accepted transaction data. As shown in FIG. 10A, in some embodiments the diversion of funds includes the provision of data indicative of diversion of funds and the quantum of funds to the promotional server, along with an electronic funds transfer of the actual funds to a specified location such as a prize pool account maintained by a financial institution.

It will be appreciated that this approach is particularly advantageous in the sense that an initial outlay is not required on the part of the retailers so as a to provide a prize pool. Rather, the prize pool accrues over time via individual transactions.

In some alternate embodiments the diversion of funds is virtual, and funds are not physically diverted until a later point in time. For example, data indicative of diversion of funds and the quantum of funds is provided to the promotional server at the time of the relevant transaction, and the transfer of actual funds is carried out on a periodic basis (such as daily or weekly) based on either of both of funds virtually diverted over a preceding period or funds anticipated to be diverted over a subsequent period.

The diversion of funds is, in some embodiments, not only to fund the prize pool, but also to provide a source of income to an administrator of the relevant sales promotion. For example, 1% of funds from each purchase transaction is diverted, and of this 0.9% is diverted to the prize pool, and 0.1% to an administration fund. In other embodiments administrator income is derived by other mechanisms as an alternative or supplement, such as flat-rate periodic payments.

### Prize Pool Generation Via Investment Return

As foreshadowed, in some embodiments the prize pool is funded in whole or in part by supplementary contribution in the form of a net investment return derived from the investment of the transaction amount, or a portion of the transaction amount, or another sum of money. Examples along such lines are considered below.

In one example, transaction based funding is used to fund a prize pool. There is a time delay between funds being provided to the prize pool (for example by way of electronic funds transfer from the retailer to a gaming service provider) and the funds being distributed as prizes. During this time, the some or all of these funds are invested in accordance with a predefined investment protocol so as to derive an investment return. For instance, an initial prize pool is defined by contributed funds. A proportion (greater than 0%, may be 100%) of this initial prize pool is invested to derive a gross investment return, including a prize portion (referred to herein as the net investment return) and a non-prize portion. An amount having a value corresponding to the net investment return is combined with the initial prize pool to provide a supplemented prize pool for distribution to the winning consumers. In some cases this amount having a corresponding value to the net investment return is the investment return itself, whereas in other cases it is a third party or operator contribution made in anticipation of, or as a substitute for, the net investment return. Another example of supplementary contribution based funding arises from the investment of the prize pool, and the addition of a portion of the resulting investment income (if any) to the prize pool. An example along these lines is shown in FIG. 10B.

Although the above example deals with investment in respect of an initial prize pool generated by way of transaction based funding, it will be appreciated that another example uses an initial prize pool that is additionally or alternately funded by way of direct funding.

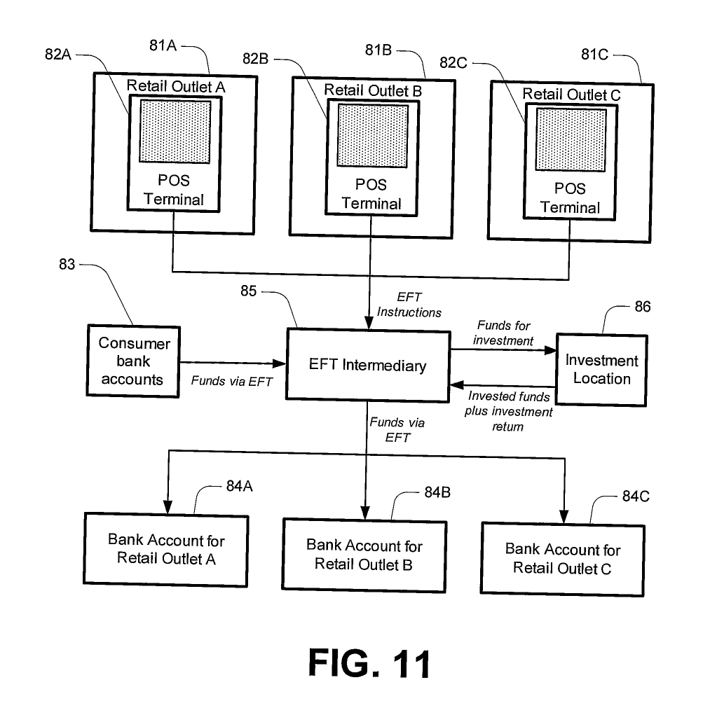

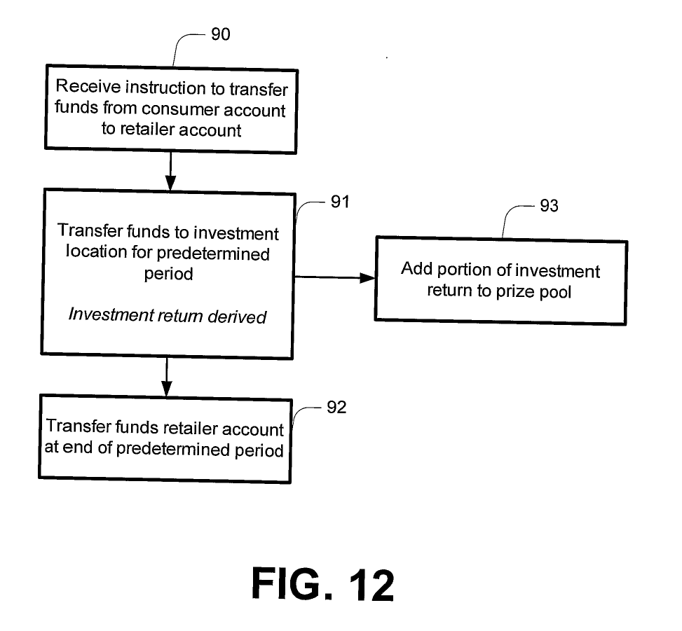

In another example, supplementary contribution in the form of an investment return is used to fund a prize pool without the need for direct funding or direct consumer contributions. This is discussed by reference to FIGS. 11 and 12.

FIG. 11 schematically illustrates a plurality of retailers 81A, 81B and 81C having respective POS terminals 82A, 82B and 82C. These POS terminals are used to allow consumers to make payments for goods and/or services. Conventionally, the POS terminals are responsible for communicating Electronic Funds Transfer (EFT) instructions over a communications network, thereby to affect the transfer of an agreed quantum of funds from consumer bank accounts 83 to the retailers' respective bank accounts 84A, 84B and 84C. In the present embodiment, an EFT intermediary is interposed between accounts 83 and accounts 84A, 84B and 84C. This intermediary receives all funds (or a predefined proportion of all funds) that are to be transferred between the consumers and the retailers, and temporarily invests these funds (schematically illustrated as investment location 86). More particularly, as shown in FIG. 12, the intermediary receives an instruction to transfer funds from consumer account to retailer account (step 90). In response, the intermediary transfers those funds to investment location 86 for a predetermined period (step 91). At the end of this period, the intermediary transfers the funds to the retailer account (step 92). A portion of the investment return derived is added to a prize pool (step 93). Any net remainder is optionally retained as an administrative commission.

The investment at location 86 is performed for a predetermined period, which is about 24 hours in some embodiments. However, in other embodiments the period ranges from a matter of hours or a number of days, weeks or months. The crux of the matter is achieving a balance between a sufficiently short timeframe such that retailers are not excessively disadvantaged by cash flow ramifications, and sufficiently long to allow generation of a reasonable return. However, on the basis that a large (and relatively uniform) amount of money will pass through the intermediary on a continuing basis, the latter consideration is perhaps less of a concern. That is, a certain stock of investment capital may be retained at all times irrespective of continuing additions and withdrawals. Indeed, in some cases, the additions and withdrawals are notional only. For example, a reconciliation method is performed periodically by which additions and withdrawals cancel each other out, but for a final period reconciliation amount, which may be applied as a single addition or withdrawal.

Any references herein to “investment return” or “investment income” are to be interpreted as references to “net investment return” and “net investment income” unless specifically stated otherwise. In practice, the investment procedure results in the derivation of a gross investment return, and various deductions (such as taxes, levies, duties, commissions, investment charges, broker fees, operator charges, and so on) are taken from this gross investment return. The term “net investment return” defines a remainder of the gross investment return, this net investment return being added to the prize pool as some or all of the supplementary income.

The terms “taxes” and “duties” as used herein are intended to encompass any relevant Federal, State and/or local government taxes, duties or imposts as well as levies or charges applied by intermediaries or other third parties connected with the gaming activity, that are essentially non-discretionary in so far as the gaming operators or consumers are concerned.

The terms “invest”, “investing”, “investment” and the like as used herein are intended to be afforded a broad interpretation covering the utilisation or disposition of funds or valuable assets in a general sense. Examples include but are not limited to, investment in any financial or real asset or property of any type, whether securitised or otherwise, with value denominated in any currency or combination of currencies, whether listed on a public trading exchange or unlisted on any such exchange, including the following, as well as warrants, options, derivatives, deferred purchase contracts, installment receipts and the like over any of the following:
Deposits with third parties whether interest-bearing or otherwise and whether held with a financial institution or some other party.
Mortgages, debt instruments or securities of any type.
Any form of American Depository Receipts or similar instruments or asset classes as may be available from time to time in any jurisdiction.
Promissory notes, bills of exchange, convertible notes, loan notes or any other form of debt or debt instrument.
Convertible or other bonds.
Preference shares, redeemable preference shares, stocks, equities or shares of any class whether fully or partly paid up.
Warrants, options, derivatives, deferred purchase contracts, installment receipts and the like.
Options, warrants or similar instruments convertible into stocks, shares or equities of any sort.
Warrants, options, derivatives, deferred purchase contracts, installment receipts or the like over any index relating to any matter including but not limited to stocks, shares or equities of any sort or futures or any financial instrument or financial asset.
Currency or interest rate swap agreements, forward interest rate agreements and the like.
Real property or property of any other kind including intellectual property.
Any contract, arrangement or instrument of any type which confers a benefit of value in relation to an item or items of value.
Futures contracts and the like in relation to any thing, item or matter.
Currencies.
Precious metals.
Works of art and any other valuables such as stamps, coins or jewels; and
Any other form of investment offering at least the potential for return on capital over a period of time, whether or not the capital is guaranteed, and whether or not a return on capital is guaranteed.
Offshore investment.
Trade in bullion or the like.
Alternatives forms of disposition of valuable assets, for example buy-back contracts and other instruments used in certain jurisdictions in light of Sharia law, or in accord with any other religious or other customs or beliefs.
   Additionally, the terms “invest”, “investing”, “investment” and the like, as used herein, should be construed as including, but not limited to, the use of one or more money management techniques to increase an available amount of funds and investing the resultant increased available amount of funds. It should also be appreciated that the “investment return” need not be cash-based or even financial in nature, provided merely that it has some intrinsic, virtual, deemed or perceived value in the broad context of the gaming activity.

Further, it should be appreciated that for the purposes of the present invention, any investment procedure (or other methodology for generating supplementary contributions for or on behalf of consumers) may be entirely invisible from the consumers' perspectives, being managed as a “back office” operation by or on behalf of the gaming operator. Indeed, in many embodiments, this is the preferred, approach, so as to shield the consumers from the detail of potentially complex investment and risk management strategies, which might otherwise detract from the experience and enjoyment of the primary gaming activity itself. This is an important distinction with respect to some forms of investment product, in which an understanding of transparent the underlying investment mechanics is primary, and any associated gaming activity is of secondary significance.

### Prize Pool Generation by Distribution Marketing

As noted above, in some embodiments the prize pool is funded in whole or in part by a supplementary contribution in the form of a net distribution marketing amount. In some such embodiments, the consumer is provided with marketing material in connection with the purchase transaction. For example, the marketing material might be printed on a receipt for the purchase transaction. Data indicative of the transaction is processed to determine one or more parties who receive marketing exposure on the basis of this marketing material, and additionally determine an exposure value attributable to the party or each of the parties. A value corresponding to this exposure value (for example, the value itself or that value less an administrator commission and/or other deductions) is added to the prize pool. In this manner, the prize pool is funded by parties who receive a marketing benefit in connection with the promotion, and the amount funded by each party is based upon a predetermined estimated unit value of marketing material actually distributed.

In one such embodiment, the marketed parties each provide a respective predetermined sum of consideration for addition to the prize pool. This sum is, over time, added to the prize pool to correspond with the actual distribution of marketing material. This is useful in the sense that each party is aware of its total liability from the outset. Furthermore, each party is able to nominate both their respective sum, and a timeframe over which it should be diminished. This allows for a distribution algorithm to be implemented such that marketing material is distributed for the relevant party at an appropriate rate.

It will be appreciated that these are particularly useful embodiments in the sense that a promotion is able to be funded by way of marketing in a manner whereby the funders' respective relative outlays correspond to exposure actually gained.

### Relationship Between Contribution and Gaming Activity

In some embodiments, there is a relationship between the contribution made by a consumer (direct and/or supplementary) and that consumer's participation in the gaming activity, with a general premise that a consumer who makes a greater contribution should be rewarded. As noted, the present embodiments include selectively awarding consumers with respective entries in a gaming activity. In some embodiments, the contribution made by a consumer affects either or both of:
(i) The probability of the consumer winning a prize based on his/her respective entry. For example, where a first consumer makes a first level of contribution, and a second consumer makes a second level of contribution that is greater than the first level of contribution, the second consumer is rewarded with a higher relative probability of winning a prize as compared with the first consumer.
(ii) A characteristic of a prize winnable by the consumer based on his/her respective entry. For example, where a first consumer makes a first level of contribution, and a second consumer makes a second level of contribution that is greater than the first level of contribution, the second consumer is rewarded with the potential of winning a more valuable prize as compared with the first consumer.

In some cases, the consumer is able to partake in optional activities at the time of transaction or the time of redemption to increase his/her level of supplementary contribution. For example, this might include completing an optional survey.

In one embodiment, a redemption terminal is provided, and when redeeming his/her entry, a consumer is invited to partake in a survey. Where the consumer elects to do so, benefits are awarded at the time of redemption (for example, a greater relative probability of winning based on the existing entry, the potential of a winning a more valuable prize based on the existing entry, or in some cases additional entries.

The manner by which the probability of the consumer winning a prize based on his/her respective entry, and/or a characteristic of a prize winnable by the consumer based on his/her respective entry is effected is, in some embodiments related not only to contribution, but to entry parameters more generally. This is discussed in more detail below.

### Entry Parameters

In some embodiments, analysis of one or more characteristics of a purchase transaction is performed to allow the definition of entry parameters for an entry that is to be defined, and these entry parameters affect either or both of:
(i) The probability of the consumer winning a prize based on his/her respective entry.
(ii) A characteristic of a prize winnable by the consumer based on his/her respective entry.

Although these effects have been briefly discussed above in the context of contribution, the term “entry parameters” is broader, and does not in all cases relate to contribution at all. For example, in some instances a retailer may prefer to allocate a predefined prize pool in advance, the total size of this prize pool being substantively unaffected by consumer behaviour (i.e. the prize pool is funded by direct funding only).

The term “entry parameters” should be read broadly to include substantially any aspect of an entry that affects some characteristic of the relationship between the consumer and the potential prize, including for example, the probability of the consumer winning a prize, a characteristic of a prize winnable by the consumer, an allowable mode of redemption, and so on. In some embodiments, each entry is associated with data indicative of one or more of these “entry parameters”.

Defining entry parameters that affect the probability of the consumer winning a prize essentially allows an operator of a trade promotion to determine instances where consumer behaviour should be rewarded with a greater probability of winning. In this vein, the probability of a consumer winning a prize is preferably increased in the case that a purchase transaction has characteristics meeting certain requirements. For example:
The probability of the consumer winning a prize may increase relative to the transaction value. The general notion is that consumers who spend more are rewarded with a greater chance of winning. In some embodiments, rather then considering the total transaction value, a portion of the transaction value attributable to a retailer profit margin is considered. Such an approach allows consumers to be rewarded in the event that they purchase goods or services which are particularly lucrative for the retailer.
The probability of the consumer winning a prize may increase in the event that particular goods or services are involved in the purchase transaction. For example, one or more products may be advertised as providing additional chances of winning. This may be particularly useful in motivating consumer behaviour such that consumers purchase certain products or brands. In some embodiments the manufacturer of a particular product contributes to the prize pool, and in exchange the probability of a consumer winning a prize is increased in the event that the consumer purchases that particular product.
The probability of the consumer winning a prize may increase in the event that the transaction takes place during a predefined period. For example, consumers are offered a greater probability of winning a prize for transactions occurring during predefined periods known to be “slow times”—times when consumer patronage at a particular retail venue is traditionally lower. This can assist to curb consumer habits by enticing consumers to shop at times when they otherwise might not.
The probability of the consumer winning a prize may increase in the event that the consumer presents a particular item to the retailer. This item might be a loyalty card, a receipt from another retail venue (for example to facilitate cross-promotion), a particular type of payment or credit card, customer information for use in subsequent marketing initiatives, and so on.
The probability of the consumer winning a prize may increase in the event that the consumer uses a certain form of payment. For example, this might be used to entice consumers to use cash rather than credit card, or one form of credit card rather then another form of credit card. Alternately, self-checkout registers may be favoured over staffed checkout registers, or online/electronic/remote transactions over interpersonal transactions.
The probability of the consumer winning a prize may increase in proportional or in a manner related to supplementary contribution, as discussed in the preceding section entitled relationship between contribution and gaming activity.

Combinations are also used. For example, in some embodiments simultaneous sub-promotions are conducted to entice consumers to spend more, shop at certain times, purchase certain products or categories of products, and the like. A consumer who does all of these things will have a greater chance of winning than a consumer who does only one or two (or none) of these things.

Various embodiments implement a number of varying techniques for affecting the probability of the consumer winning a prize. A general approach is to assign a predetermined number of chances to an entry in response to characteristics of the purchase transaction. The probability of the consumer winning a prize is related to the number of chances assigned to that entry. For example, as discussed above, one or more “entry numbers” may be assigned to a single entry, the probability of that entry winning a prize increasing with the number of entry numbers. It will be appreciated that, if what is described herein as an “entry” having an “entry identifier” is instead thought of as a “ticket” having a “ticket identifier”, it is conceptually possible to assign what could be regarded as multiple entries to a single ticket. This is, in practice, no different from assigning multiple entry numbers to a single entry.

Other techniques for assigning a predetermined number of chances assigned to the entry are discussed below:
In some embodiments an entry is associated with bonus entries. For example, the consumer is provided with a single entry (and single entry identifier). At the point of sale, however this entry is associated with none, one or more bonus entries. The more bonus entries associated with a particular entry, the greater the probability of wining. From a practical perspective, the redemption process is commenced on the basis of the “standard” entry, and the consumer is notified of a win in the event that either the standard entry or one or the associated bonus entries is a winning entry.
In some embodiments, chances are defined notionally. That is, rather than a particular entry having physically observable “chances” (such as entry numbers or bonus entries), a mathematical weighting is applied to each entry. An algorithm used to identify winning entries is configured to be responsive to that weighting such that the weighting affects the probability of that entry being identified as a winner.

From these examples, it will be appreciated that the notion of “assigning chances” should be interpreted broadly as encompassing both physical mechanisms such as bonus entries, as well as virtual mechanisms such as mathematical algorithms, to achieve the desired modification of the dynamic probability profile associated with particular customers.

It will be appreciated that alternative approaches are implemented in further embodiments.

As previously indicated, defining entry parameters that affect a characteristic of a prize winnable by the consumer may be conveniently used to entice particular consumer behaviours. In some embodiments, prize characteristics include either the magnitude of the prize (such as a cash amount), or the nature of the prize (such as whether the prize is cash, goods or services, a set amount, a periodically increasing jackpot, and so on). In some examples where the magnitude is affected, in the event that the transaction meets predefined criteria (for example a threshold transaction value, a particular transaction time, the purchase of specified goods or services, etc), an entry awarded in respect of that transaction has one or more chances to win a larger prize. In one embodiment, transactions having a transaction value of less than $X compete for a first prize, and transactions having a transaction value of greater than $X compete for larger second prize (either separately from or in combination with the first prize).

In some examples where the nature of the prize is affected, prizes may include the likes of cars, bikes, vouchers, massages, holidays, and so on. In one embodiment, a consumer who enters into a transaction meeting base-level requirements is provided with an entry into a cash draw. Additionally, a particular manufacturer provides a car as a prize, and a consumer that purchases a product from that manufacturer is provided with an entry into the cash draw and an entry into a further draw for the car.

In some embodiments, defining the entry parameters for the entry includes selecting one or more of a plurality of prize classes for association with the entry, each prize class defining one or more winnable prizes, wherein the selection of one or more prize classes is based on one or more predetermined characteristics of the purchase transaction. In some embodiments a given entry may be associated with a number of classes, whilst in other embodiments each entry is associated with only one class.

An example of where classes may be used is in the context of multiple prize pools. Each prize pool includes one or more prizes, varying in nature and or magnitude. For example, one prize pool includes a plurality of cash prizes of varying magnitude, another prize pool includes various goods including a car, holiday and children's toys, and another prize pool includes a combination of cash and products donated by a particular manufacturer. Based on characteristics of a particular initiating transaction, an entry is defined to and associated with one or more of these prize pools so as to provide the opportunity to compete for that one or more of the prize pools.

In some embodiments multiple prize pools, include a major prize pool and a minor prize pool are provided. In one embodiment, in the event that a purchase transaction meets base-level criteria, an entry is defined and associated with the minor prize pool. In the event that the transaction meets more demanding criteria (for example a threshold transaction value, a particular transaction time, the purchase of specified goods or services, etc), the entry is additionally or alternatively associated with the major prize pool.

In some embodiments both the probability of winning a prize and a characteristic of the prize winnable are both affected. A hypothetical example is considered below. This is provided for illustration only, and should not be regarded as limiting in any way. In this example, a computer system is enabled to implement the following rules for allowing the definition of entries and entry parameters:
Assess the following transaction characteristics: transaction value, time of transaction, method of payment, and goods purchased.
If the transaction value $T is greater than $10, define entry, associate entry with Prize Pool A.
Associate with entry $T/10 bonus entries, these entries being associated with Prize Pool A.
If the method of payment is cash, associate with entry 10 bonus entries, these entries being associated with Prize Pool A.
If the transaction time is between 11 AM and 3 PM, associate with entry $T/10 bonus entries, these entries being associated with Prize Pool A.
If the transaction value $T is greater than $Y, associate entry with Prize Pool B.
Associate with entry $T/100 bonus entries, these entries being associated with Prize Pool B.
If the goods purchased include Product Z, associate entry with Prize Pool C.

Assume a consumer enters into a transaction at 1:00 PM for goods including Product Z, and the transaction value is $500, paying cash. This consumer is provided with a single entry that has 111 chances (1 standard chance, plus 50 bonus entry chances based on transaction value, plus 10 bonus entry chances for paying cash, plus 50 bonus It will be appreciated that the above description provides various systems and methods for conducting sales promotions that at least to a degree ameliorate disadvantages associated with the likes of known loyalty schemes. For example, the above systems and methods provide avenue whereby a participant is able to substantially immediately redeem benefits derived. Additionally, the inclusion of a chance aspect may serve to increase enticement and offer a significant commercial advantage to participating retailers. Furthermore, the ability to share the funding of prizes amongst participating retailers may allow for the offer of significant prizes for a fairly nominal per-transaction outlay.

us entry chances as a time of day bonus) to win Prize Pool A, 6 chances to win Prize Pool B (1 standard chance, plus 5 bonus entry chances based on transaction value), and one chance to win Prize Pool C.

In this way, it will be appreciated that the nature of the prizes, the value of the prizes and/or the probability of winning the prizes are all selectively variable in real-time, in response to a particular set of predetermined characteristics of purchase transactions, thereby to provide the retailer with the opportunity to directly influence consumer behaviour according to predetermined criteria that can be highly customised to suit the needs of specific retailers.

In some embodiments the purchase transaction takes place between a consumer, in the form of an account holder, and a retailer, in the form of a financial institution. Examples of such transactions include cash withdrawals from automatic teller machines, the purchase or sale of bonds, shares and other securities, online or electronic payment transactions, conventional teller transactions, the opening of new accounts, the procurement of personal or other loans, and so on. In each of these examples, the subject matter of the purchase transaction is a service provided by the financial institution. For instance, in the case of a cash withdrawal from an automatic teller machine, the account holder essentially purchases a use of the relevant machine and underlying infrastructure. There is not necessarily always a direct charge for this purchase.

In some embodiments where the purchase transaction takes place between an account holder and a financial institution, entries are awarded to provide to customers firstly an incentive to use that particular financial institution, and secondly an incentive to use particular services offered by that financial institution. For example, entries are awarded in a manner so as to encourage account holders to make use of electronic banking methods rather then interpersonal banking methods.

### Progressive Prize Pools

In some embodiments, the prize pool increases over time. This is particularly the case where consumer contribution based funding is used. However, in some embodiments a prize pool having a predetermined total value (i.e. a prize pool funded by direct funding only) also displays progressive characteristics. An example along such lines is considered below.

In this example, the prize pool is predetermined. In particular, from the outset, those parties responsible for funding the prize pool are aware of their total liability in respect of providing such funding. However, although the prize pool has a predefined total quantum, only a designated portion of that total quantum is available to be awarded as prizes at any given point in time. Furthermore, this designated portion increases over time responsive to consumer activity. For example, the designated portion increases subject to each transaction (or each transaction satisfying predefined criteria) by either a flat rate or an amount related to the transaction value. This is similar to the example of transaction based funding, although the funding is pre-existing, and does not arise from the transactions themselves. Rather, the transactions affect availability of pre-existing funding.

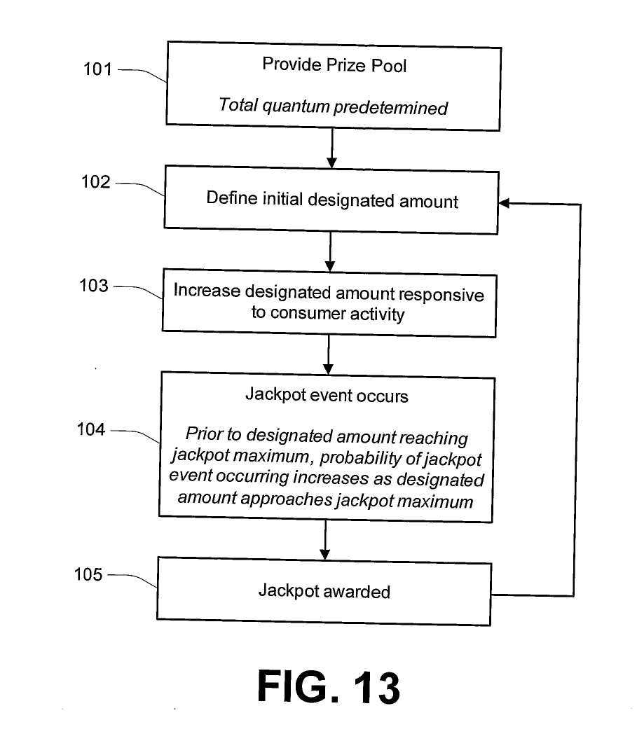

In some embodiments, the designated portion behaves like a progressive gaming jackpot, as shown in FIG. 13. A prize pool having a predetermined total quantum is provided at 101. At the commencement of a promotional period, an initial designated amount is defined at 102. This is, in some cases, zero. The designated amount is increased responsive to consumer activity at 103. For example, data indicative of transaction amounts (i.e. consumer spend levels) is collected and processed and, based on that processing, the designated amount increases at a variable rate. A jackpot module is configured to randomly identify a jackpot event, within set constraints. These set constraints essentially result in a jackpot event occurring prior to the designated amount reaching a prescribed jackpot maximum, and optionally operate such that the probability of the jackpot event occurring increases as the designated amount approaches the prescribed jackpot maximum. That is, there exists a higher likelihood of a jackpot event occurring at higher designated amounts than lower designated amounts. Various appropriate jackpot modules and associated technology are known in the field of electronic gaming machines

A jackpot event occurs at 104, and the corresponding designated amount is awarded as a prize at 105. Additionally, after the jackpot event occurs, the method loops to 102.

In some embodiments the jackpot module is configured such that the total amount awarded in prizes over a given promotional period is equal to or less than the total quantum of the prize pool.

### Exemplary Promotional Software

In a further embodiment, a sales promotion is conducted in part by a promotional software package executing on a POS terminal having a memory module coupled to one or more processors. This POS terminal is also coupled to a barcode scanner for scanning goods for sale, and a coupon printer for printing receipts in respect of purchase transactions.

The promotional software package receives data indicative of a purchase transaction between a consumer and a retailer, this purchase transaction having a transaction value. It then provides a signal indicative of the purchase transaction to administration subsystem, presently being a promotional server such as that described above. This server is responsive to the signal indicative of the purchase transaction for selectively defining an entry for the consumer and, in the case than an entry is defined, providing a first return signal indicative of the entry to the POS terminal. This signal is received by the software package, which arranges for the coupon printer to include on the receipt for the relevant transaction a barcode indicative of the entry.

In this embodiment, a redemption request is placed by scanning the barcode carried by the receipt. The software package monitors the activity of the barcode scanner to identify the scanning of such a barcode, and in response arranges for redemption of the entry at the promotional server. A reply is received, and the software package used display means coupled to the POS terminal to indicate whether or not a prize is to be awarded.

Although some embodiments used herein make use of barcode technology, it will be appreciated that other embodiments use alternate technologies. That is, it will be appreciated that a barcode is used to provide a convenient machine-readable identifier. Other technologies that provide machine-readable identifiers, and that are used in alternate embodiments, include Optical Character Recognition (OCR) technology, magnetic strip technology, biometric technology, and radio frequency identification (RFID) technology.

It will be appreciated that barcode technology allows for convenient printing of an identifier onto a substrate, however, other technologies do not. Rather, these technologies have preset identifiers. Prime examples include RFID tags and biometric information. In embodiments using such technologies, the preset identifier is preferably associated in a database with an entry identifier indicative of an entry. By this approach, recognition of the preset identifier allows validation of that entry. In one embodiment consumers are provided with re-usable entry cards carrying embedded RFID tags indicative of unique preset identifiers. In another embodiment the preset identifier is “borrowed” from an item already carried by the consumer, such as a credit card. In still another embodiment the consumer provides the preset identifier by other means, for example by way of biometric technologies (for example an alphanumeric identifier is defined on the basis of the consumers fingerprint). In another embodiment the preset identifier is simply a password of identification number defined by the consumer.

Similar approaches are implemented in respect of other technologies, and those skilled in the art will appreciate the manner by which embodiments are implemented using such technologies. In a further embodiment, particularly designed for retail locations having a high throughput (such as a fast-food chain), redemption occurs as soon as the transaction is finalised. In the case that a prize is to be awarded, that is communicated to the consumer substantially immediately to create a temporal nexus between the transaction and the prize. For example, whenever a prize is won, lights flash or a message is displayed on a display screen so as to identify the consumer interacting with retailer as a winner.

### General Observations

Unless specifically stated otherwise, as apparent from the following discussions, it is appreciated that throughout the specification discussions utilizing terms such as “processing,” “computing,” “calculating,” “determining” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. Each processor may include one or more of a CPU, a graphics processing unit, and a programmable DSP unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display may be included, e.g., a liquid crystal display (LCD) or a cathode ray tube (CRT) display. If manual data entry is required, the processing system also includes an input device such as one or more of an alphanumeric input unit such as a keyboard, a pointing control device such as a mouse, and so forth. The term memory unit as used herein, if clear from the context and unless explicitly stated otherwise, also encompasses a storage system such as a disk drive unit. The processing system in some configurations may include a sound output device, and a network interface device. The memory subsystem thus includes a computer-readable carrier medium that carries computer-readable code (e.g., software) including a set of instructions to cause performing, when executed by one or more processors, one of more of the methods described herein. Note that when the method includes several elements, e.g., several steps, no ordering of such elements is implied, unless specifically stated. The software may reside in the hard disk, or may also reside, completely or at least partially, within the RAM and/or within the processor during execution thereof by the computer system. Thus, the memory and the processor also constitute computer-readable carrier medium carrying computer-readable code.

Furthermore, a computer-readable carrier medium may form, or be includes in a computer program product.

In alternative embodiments, the one or more processors operate as a standalone device or may be connected, e.g., networked to other processor(s), in a networked deployment, the one or more processors may operate in the capacity of a server or a client machine in server-client network environment, or as a peer machine in a peer-to-peer or distributed network environment. The one or more processors may form a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine.

Note that while some diagrams only show a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

The software may further be transmitted or received over a network via a network interface device. While the carrier medium is shown in an exemplary embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fiber optics, including the wires that comprise a bus subsystem. Transmission media also may also take the form of acoustic or light waves, such as those generated during radio wave and infrared data communications. For example, the term “carrier medium” shall accordingly be taken to included, but not be limited to, solid-state memories, a computer product embodied in optical and magnetic media, a medium bearing a propagated signal detectable by at least one processor of one or more processors and representing a set of instructions that when executed implement a method, a carrier wave bearing a propagated signal detectable by at least one processor of the one or more processors and representing the set of instructions a propagated signal and representing the set of instructions, and a transmission medium in a network bearing a propagated signal detectable by at least one processor of the one or more processors and representing the set of instructions.

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are intended to be within the scope of the invention, and form different embodiments, as would be understood by those in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner. Similarly, the various methods recited in the description and claims are not intended to be limited to any particular temporal sequence of method steps, whether sequentially numbered or otherwise, unless the context clearly dictates otherwise. In many instances, both essential and preferable method steps may be performed in a sequence that is different to that recited and furthermore, in many instances, a plurality of steps may be performed simultaneously.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

Similarly, it is to be noticed that the term coupled, when used in the claims, should not be interpreted as being limitative to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Finally, those skilled in the art will understand that regulations are often placed on the carriage of sales promotions such as those disclosed herein, these regulations varying between jurisdictions. It will be appreciated that various embodiments disclosed herein may require some modification for regulatory compliance, and such modifications may be made thereto without departing from the spirit of the invention, and it is intended to claim all such changes and modifications as fall within the scope of the invention.

1. A method for conducting a sales promotion, the method including:
receiving data indicative of a purchase transaction between a consumer and a retailer, the purchase transaction having a transaction value;
being responsive to the data for selectively defining an entry in a chance-based gaming activity for the consumer in relation to the purchase transaction, wherein the purchase transaction is for goods and/or services unrelated to the chance-based gaming activity;
processing the data to determine a supplementary contribution amount for the consumer; and
providing a prize pool from which prizes are to be awarded in relation to the change-based gaming activity, wherein the prize pool is funded at least in part by a value corresponding to the supplementary contribution amount.

2. A method according to claim 1 including the step of:
in the case that an entry is defined, being responsive to one or more characteristics of the purchase transaction for determining a consumer direct contribution amount, wherein the prize pool is additionally funded at least in part by a value corresponding to the consumer direct contribution amount.

3. A method according to claim 2 wherein the consumer direct contribution is determined to be a proportion of the transaction value.

4. A method according to claim 1 wherein the supplementary contribution amount includes a net investment return derived from the investment of the transaction amount.

5. A method according to claim 1 wherein the supplementary contribution amount includes a net investment return derived from the investment of a proportion of the transaction amount.

6. A method according to claim 2 wherein the supplementary contribution amount includes a net investment return derived from the investment of a value corresponding to the consumer direct contribution.

7. A method according to claim 1 wherein the supplementary contribution amount includes a net distribution marketing amount.

8. A method according to claim 7 wherein the net distribution marketing amount is derived from a gross distribution marketing amount provided by a third party in consideration for marketing material being provided to the consumer in connection with the purchase transaction.

9. A method according to claim 8 wherein the marketing material is printed on a transaction receipt for the purchase transaction.

10. A method according to claim 1 wherein the supplementary contribution amount includes a net collection marketing amount.

11. A method according to claim 10 wherein the net collection marketing amount is derived from a gross collection marketing amount provided by a third party in consideration to marketing information being obtained in relation to the consumer in connection with the purchase transaction.

12. A method according to claim 1 wherein the supplementary contribution amount affects the relative probability of the consumer winning a prize based on his/her respective entry.

13. A method according to claim 1 wherein the supplementary contribution amount affects a characteristic of a prize winnable by the consumer based on his/her respective entry.

14. A method according to claim 1 including the steps of:
receiving data indicative of a redemption request placed in respect of the entry at either or both of the time of completion of the retail transaction and a time selected by the consumer;
being is responsive to the redemption request for substantially immediately determining whether or not to award a prize to the consumer based on the outcome of the chance-based gaming activity, wherein the prize is defined by a portion of the prize pool.

15. A method according to claim 14 including the step of processing data associated with the redemption request for selectively attributing an additional supplementary contribution to the consumer.

16. A method according to claim 14 including the step of substantially immediately informing the consumer whether or not a prize is to be awarded.

17. A method for providing a prize pool for a sales promotion, the method including the steps of:
receiving data indicative of an instruction to transfer funds corresponding to a transaction value for a purchase transaction between a consumer and a retailer from a consumer account to a retailer account;
providing the funds to a third location for a predefined period to derive a gross investment return including a supplementary contribution amount for the consumer;
at the end of the predefined period, transferring the funds to the second location; and
adding a value corresponding to the supplementary contribution amount to the prize pool.

18. A method for conducting a sales promotion, the method including:
receiving data indicative of a purchase transaction between a consumer and a retailer, wherein the consumer is provided with marketing material in connection with the purchase transaction;
being responsive to the data for selectively defining an entry in a chance-based gaming activity for the consumer in relation to the purchase transaction, wherein the purchase transaction is for goods and/or services unrelated to the chance-based gaming activity;
processing the data to determine a supplementary contribution amount for the consumer, the supplementary contribution amount including a net distribution marketing amount related to the provision of the marketing material to the consumer; and
providing a prize pool from which prizes are to be awarded in relation to the change-based gaming activity, wherein the prize pool is funded at least in part by a value corresponding to the supplementary contribution amount.

19-29. (canceled)
